(19) United States
(12) Patent Application Publication
(10) Pub. No.: US 2008/0262044 A1
(43) Pub. Date: Oct. 23, 2008

(54) Pesticidal Mixtures

(75) Inventors: Ana Cristina Dutton, Stein (CH); Roger Graham Hall, Basel (CH); Andre Jeanguenat, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Participations AG, Basel (CH)

(21) Appl. No.: 11/909,991

(22) PCT Filed: Apr. 6, 2006
(86) PCT No.: PCT/EP2006/003133

§ 371 Date: May 1, 2008

(30) Foreign Application Priority Data
Apr. 8, 2005 (CH) 637/05

(51) Int. Cl. A01N 43/40; A01P 1/00; A01P 7/04; A01P 7/02

(52) U.S. Cl. 514/341

(57) ABSTRACT

The present invention relates to a synergistically effective pesticidal composition which comprises, on the one hand, a bisamide and, on the other hand, known fungicidal active ingredients and which is accordingly very well suited to controlling undesirable animal pests such as insects and acarids and also undesirable phytopathogenic fungi.

The invention relates to synergistically effective pesticidal compositions which comprise, on the one hand, a bisamide and, on the other hand, known fungicidal active ingredients and which are accordingly very well suited to controlling undesirable animal pests such as insects and acarids and also undesirable phytopathogenic fungi.

Certain pesticidal compositions are proposed in the literature, for example in WO 03/015518, WO 04/067528 and WO 2006/007595. The properties of those known compositions in the field of pest control are not, however, entirely satisfactory.

It is also known that imidazole, triazole, strobilurin and aniline derivatives, dicarboximides and other heterocyclic compounds have fungicidal action and can be used in controlling fungi. Such fungicides are described, for example, in “The Pesticide Manual” [The Pesticide Manual—A World Compendium; Thirteenth Edition; Editor: C. D. S. Tomlin; The British Crop Protection Council] or on the Internet under “Compendium of Pesticide Common Names”, under the address http://www.alanwood.net/pesticides/. The action of those substances is also not always sufficient at the desired low rates of application.

Novel pesticidal compositions having very good insecticidal, acaricidal and fungicidal properties have now been found which, in addition to comprising adjuvants, comprise as active ingredients

a) as component (A), a compound of formula I

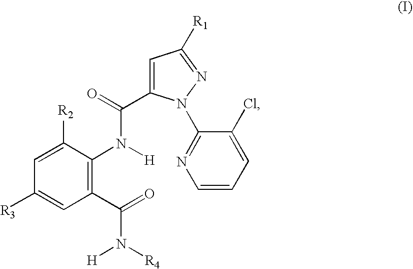

wherein
R₁ is halogen, C₁-C₄haloalkyl or C₁-C₄haloalkoxy;
R₂ is halogen or C₁-C₄alkyl;
R₃ is halogen or cyano; and
R₄ is C₁-C₄alkyl; and

b) as component (B), a synergistically effective amount of at least one active ingredient selected from the group consisting of compounds from the class of azoles, pyrimidinyl carbinols, 2-aminopyrimidines, morpholines, anilinopyrimidines, pyrroles, phenylamides, benzimidazoles, dicarboximides, carboxamides, guanidines, strobilurins, dithiocarbamates, N-halomethylthiotetrahydrophthalimides, copper-containing compounds, nitrophenol derivatives, organo-phosphorus derivatives, a compound of formula F-1

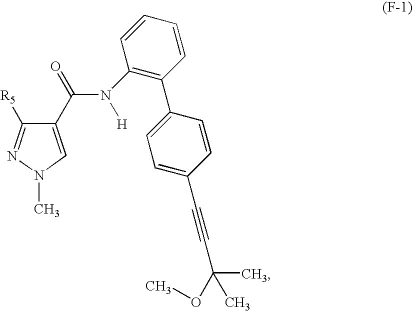

wherein R₅ is trifluoromethyl or difluoromethyl;
and a compound of formula F-2

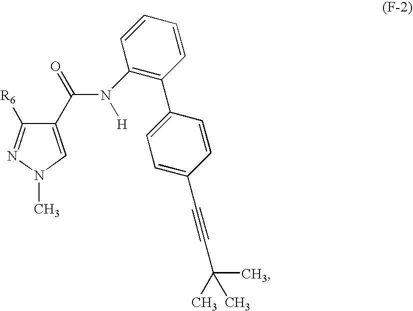

wherein R₆ is trifluoromethyl or difluoromethyl;
and a racemic compound of formula F-3 (syn)

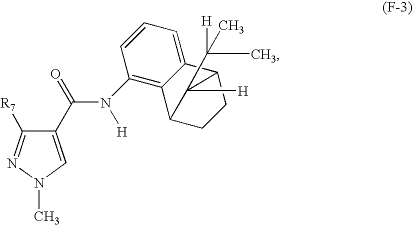

wherein R₇ is trifluoromethyl or difluoromethyl; and a racemic compound of formula F-4 (anti)

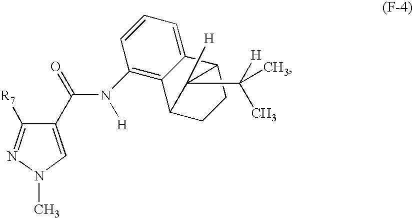

wherein R₇ is trifluoromethyl or difluoromethyl; and a compound of formula F-5

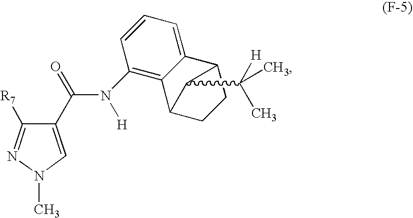

which constitutes an epimeric mixture of the racemic compounds of formulae F-3 (syn) and F-4 (anti), wherein the ratio of the racemic compounds of formula F-3 (syn) to the racemic compounds of formula F-4 (anti) is from 1000:1 to 1:1000 and wherein R₇ is trifluoro-methyl or difluoromethyl; and a compound of formula F-6

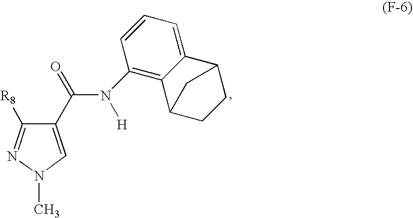

wherein R₈ is trifluoromethyl or difluoromethyl; and a racemic compound of formula F-7 (trans)

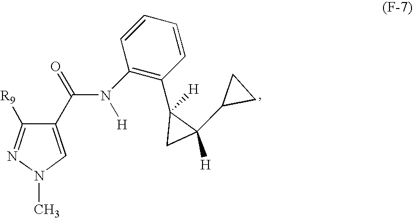

wherein R₉ is trifluoromethyl or difluoromethyl; and a racemic compound of formula F-8 (cis)

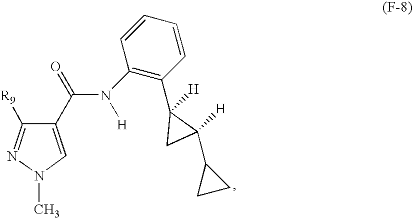

wherein R₉ is trifluoromethyl or difluoromethyl; and a compound of formula F-9

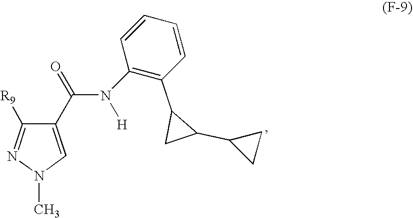

which constitutes a mixture of the racemic compounds of formulae F-7 (trans) and F-8 (cis), wherein the ratio of the racemic compound of formula F-7 (trans) to the racemic compound of formula F-8 (cis) is from 2:1 to 100:1 and wherein R₉ is trifluoromethyl or difluoromethyl; and a compound of formula F-10

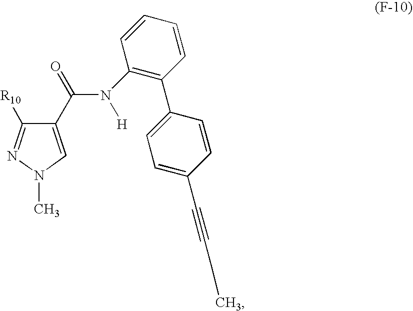

wherein R₁₀ is trifluoromethyl or difluoromethyl; and a racemic compound of formula F-11 (trans)

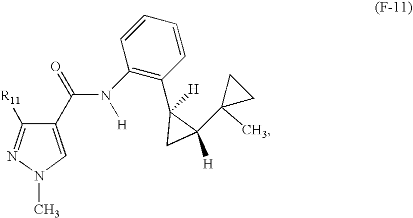

wherein R₁₁ is trifluoromethyl or difluoromethyl; and a racemic compound of formula F-12 (cis)

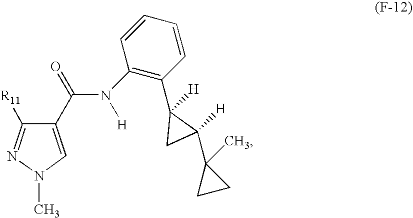

wherein R₁₁ is trifluoromethyl or difluoromethyl; and a compound of formula F-13

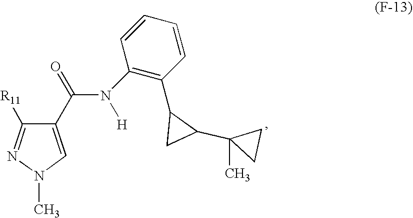

which constitutes a mixture of the racemic compounds of formulae F-11 (trans) and F-12 (cis) and wherein R₁₁ is trifluoromethyl or difluoromethyl; and a compound of formula F-14

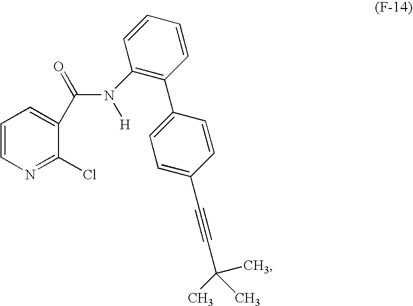

and the compounds acibenzolar-5-methyl, anilazine, benthiavalicarb, blasticidin-S, chinomethionat, chloroneb, chlorothalonil, cyflufenamid, cymoxanil, dichione, diclocymet, diclomezine, dicloran, diethofencarb, dimethomorph, SYP-L190 (flumorph), dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, IKF-916 (cyazofamid), kasugamycin, methasulfocarb, metrafenone, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide (RH7281) and mandipropamid.

The alkyl groups appearing in the substituent definitions may be straight-chain or branched and are, for example, methyl, ethyl, n-propyl, isopropyl, n-butyl, sec-butyl, isobutyl and tert-butyl. Haloalkyl and haloalkoxy groups are derived from the mentioned alkyl groups.

Halogen is generally fluorine, chlorine, bromine or iodine, preferably fluorine or chlorine. The same is true of halogen in conjunction with other meanings, such as haloalkyl or haloalkoxy. Haloalkyl groups preferably have a chain length of from 1 to 4 carbon atoms. Haloalkyl is, for example, fluoromethyl, difluoromethyl, trifluoromethyl, chloromethyl, dichloromethyl, trichloromethyl, 2,2,2-trifluoroethyl, 2-fluoroethyl, 2-chloroethyl, pentafluoroethyl, 1,1-difluoro-2,2,2-trichloroethyl, 2,2,3,3-tetrafluoroethyl and 2,2,2-trichloroethyl; preferably trichloromethyl, difluorochloromethyl, difluoromethyl, trifluoromethyl and dichlorofluoromethyl.

Preferred compositions according to the invention comprise, as active ingredients (A), a compound selected from the group consisting of

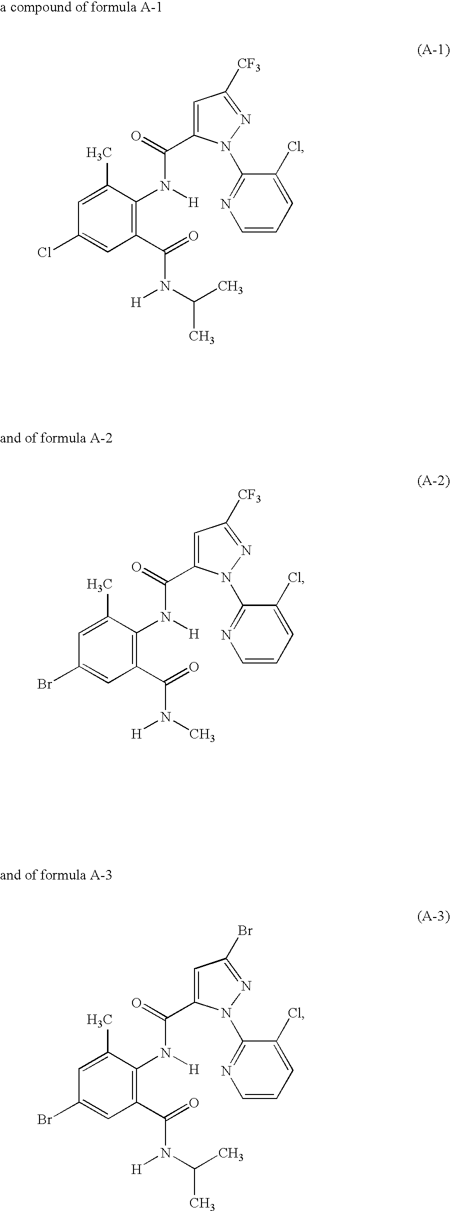

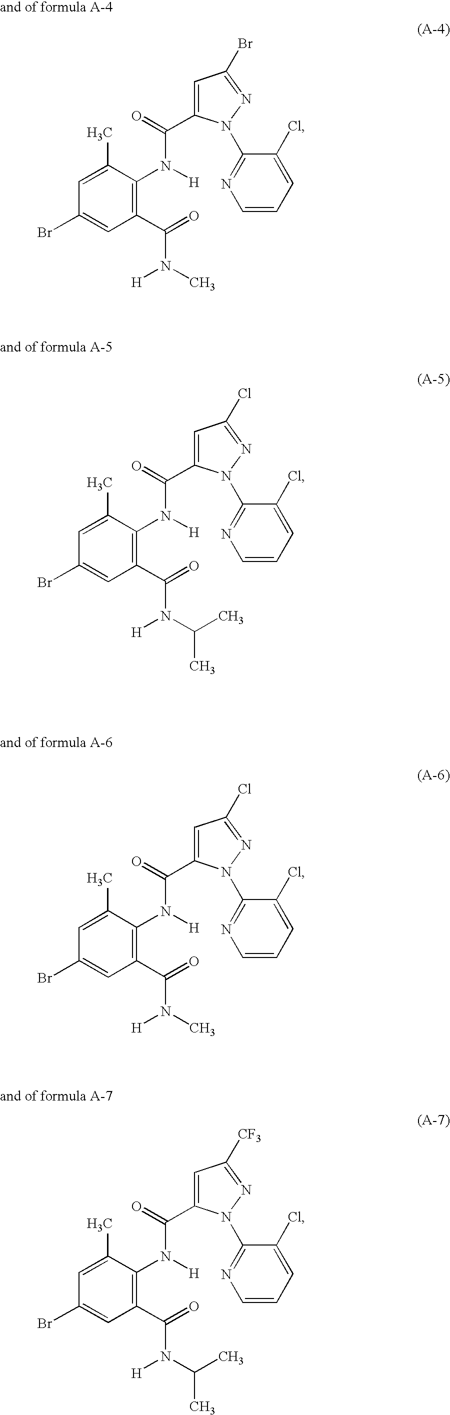

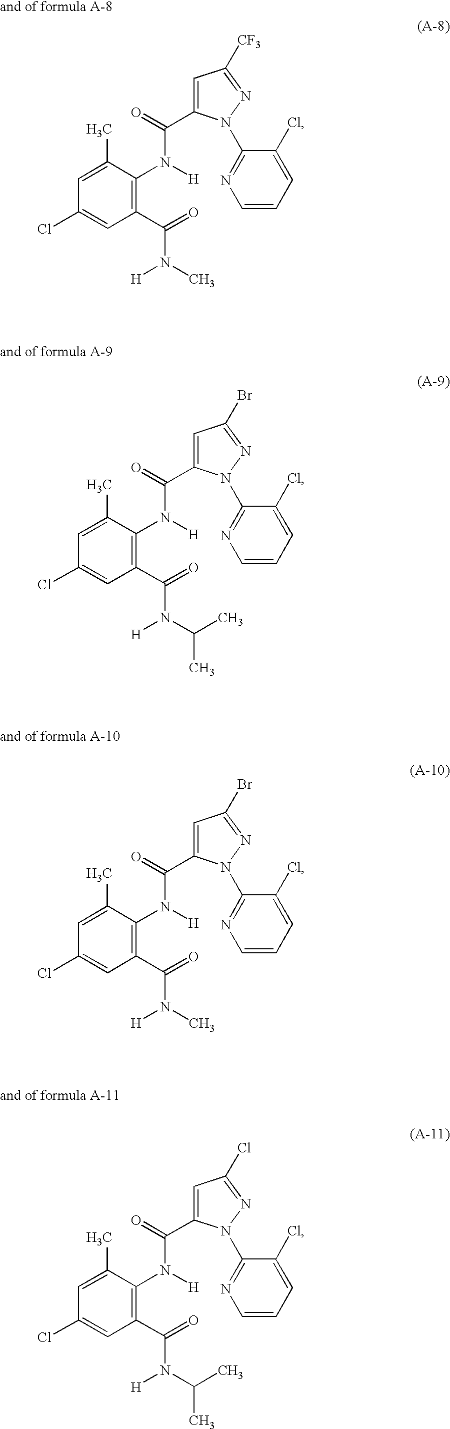

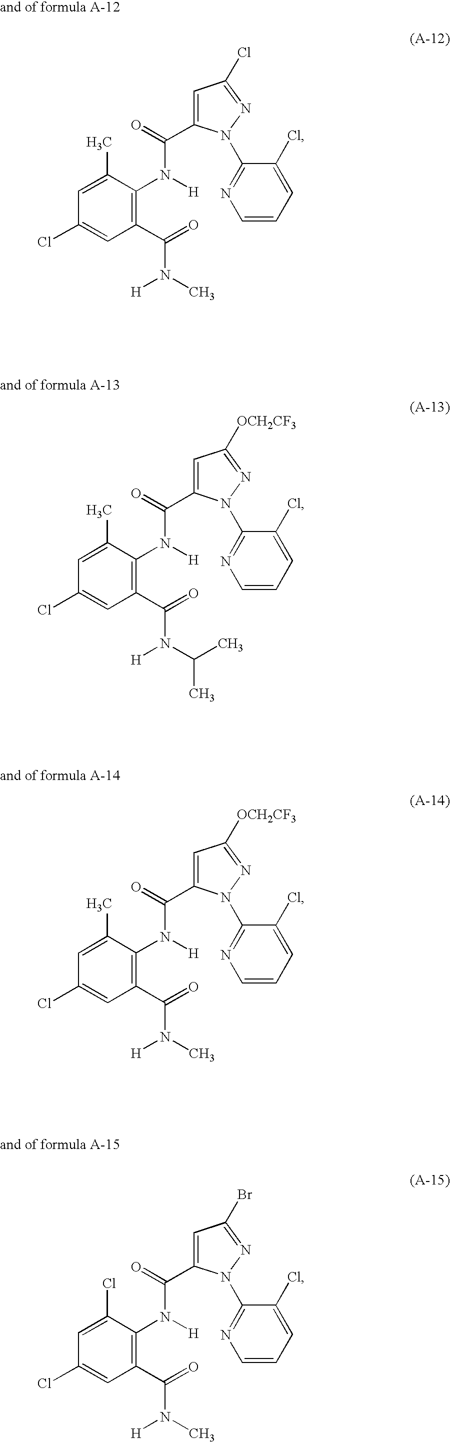

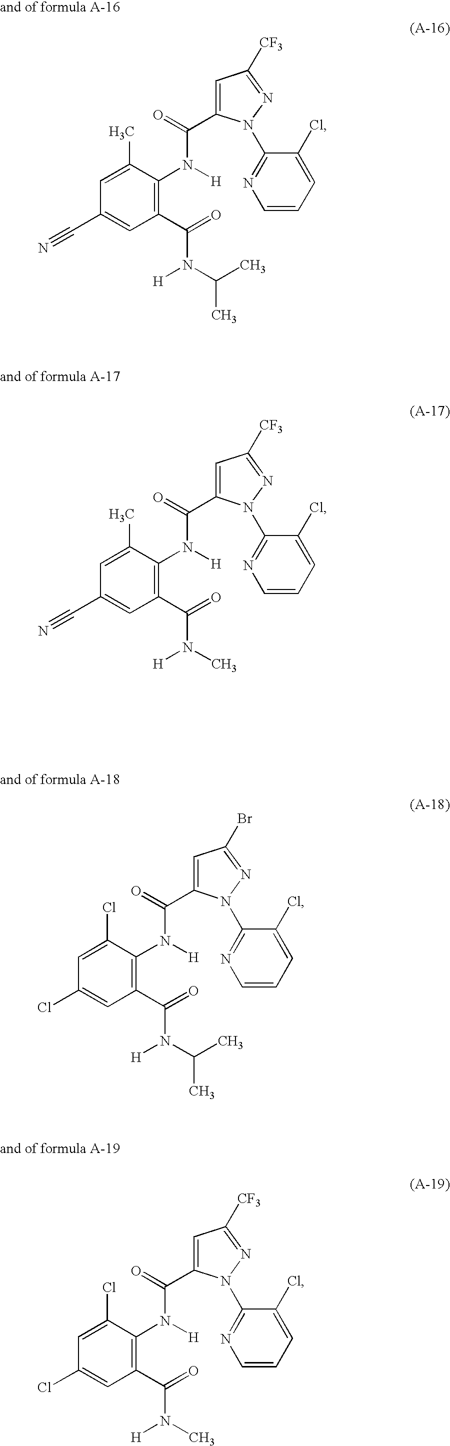

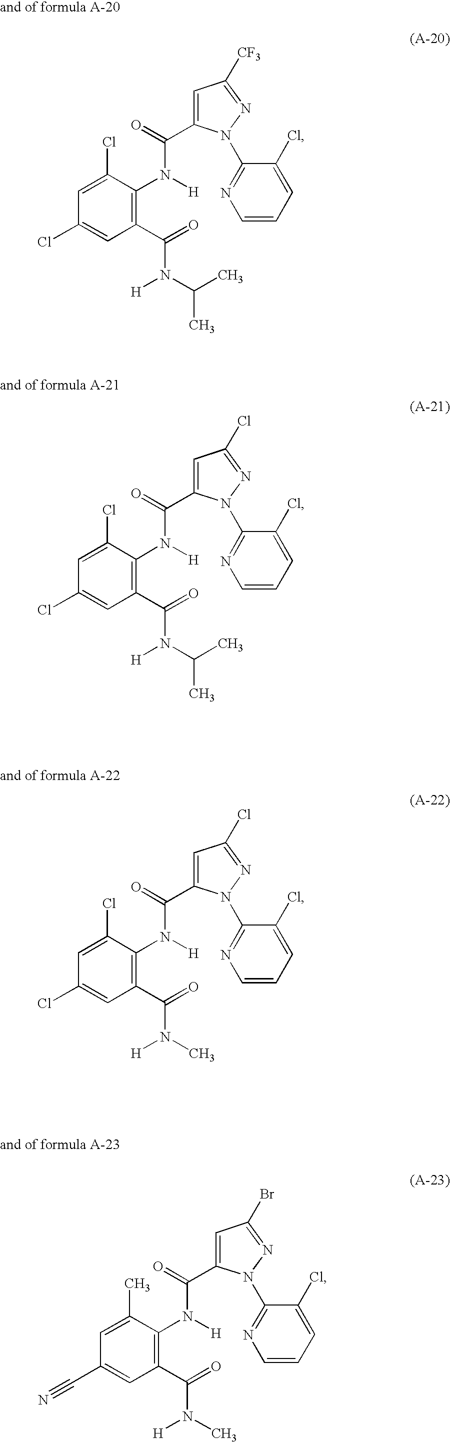

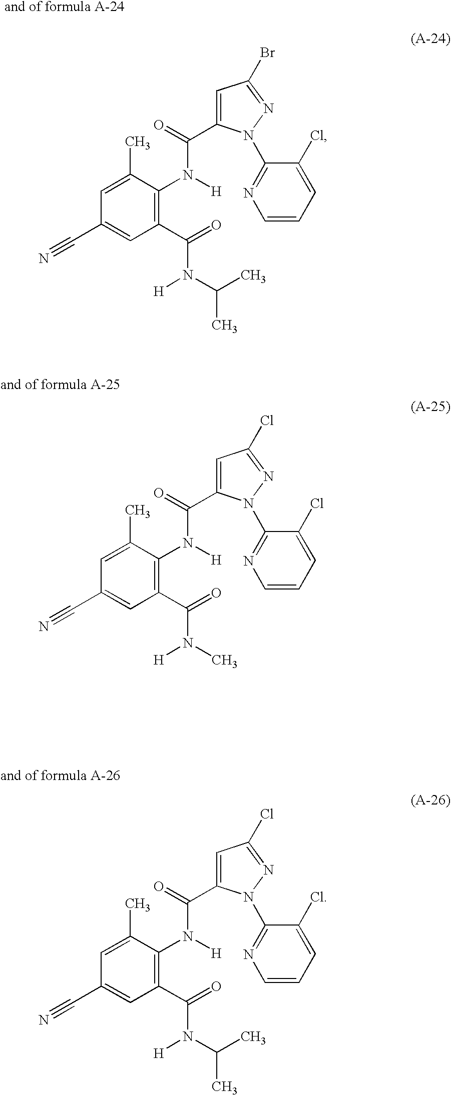

Preference is also given to those compositions according to the invention which comprise, as active ingredients (B),

an azole selected from azaconazole, bitertanol, bromuconazole, cyproconazole, difenoconazole, diniconazole, epoxiconazole, fenbuconazole, fluquinconazole, flusilazole, flutriafol, hexaconazole, imazalil, imibenconazole, ipconazole, metconazole, myclobutanil, pefurazoate, penconazole, prothioconazole, pyrifenox, prochloraz, propiconazole, simeconazole, tebuconazole, tetraconazole, triadimefon, triadimenol, triflumizole and triticonazole; or
a pyrimidinyl carbinol selected from ancymidol, fenarimol and nuarimol; or
a 2-aminopyrimidine selected from bupirimate, dimethirimol and ethirimol; or
a morpholine selected from dodemorph, fenpropidin, fenpropimorph, spiroxamine and tridemorph; or
an anilinopyrimidine selected from cyprodinil, mepanipyrim and pyrimethanil; or
a pyrrole selected from fenpiclonil and fludioxonil; or
a phenylamide selected from benalaxyl, furalaxyl, metalaxyl, R-metalaxyl, ofurace and oxadixyl; or
a benzimidazole selected from benomyl, carbendazim, debacarb, fuberidazole and thiabendazole; or
a dicarboximide selected from chlozolinate, dichlozoline, iprodione, myclozolin, procymidone and vinclozolin; or
a carboxamide selected from boscalid, carboxin, fenfuram, flutolanil, mepronil, oxycarboxin, penthiopyrad and thifluzamide; or
a guanidine selected from guazatine, dodine and iminoctadine; or
a strobilurin selected from azoxystrobin, dimoxystrobin (SSF 129), enestroburin, fluoxastrobin, kresoxim-methyl, metominostrobin, trifloxystrobin, orysastrobin, picoxystrobin and pyraclostrobin; or
a dithiocarbamate selected from ferbam, mancozeb, maneb, metiram, propineb, thiram, zineb and ziram; or
an N-halomethylthiotetrahydrophthalimide selected from captafol, captan, dichlofluanid, fluoroimide, folpet and tolylfluanid; or
a copper compound selected from Bordeaux mixture, copper hydroxide, copper oxychloride, copper sulfate, copper oxide, mancopper and oxine-copper; or
a nitrophenol derivative selected from dinocap and nitrothal-isopropyl; or
an organo-phosphorus derivative selected from edifenphos, iprobenfos, isoprothiolane, phosdiphen, pyrazophos and tolclofos-methyl; or a compound selected from acibenzolar-S-methyl, anilazine, benthiavalicarb, blasticidin-S, chinomethionat, chloroneb, chlorothalonil, cyflufenamid, cymoxanil, dichlone, diclocymet, diclomezine, dicloran, diethofencarb, dimethomorph, SYP-L190 (flumorph), dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, IKF-916 (cyazofamid), kasugamycin, methasulfocarb, metrafenone, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide (RH7281) and mandipropamid, or a compound selected from a compound of formula F-1

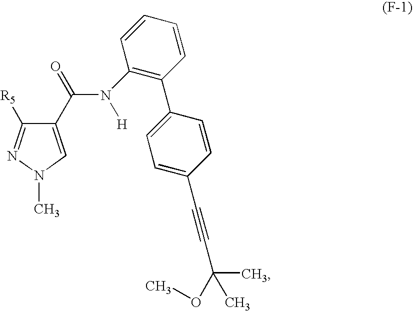

wherein R₅ is trifluoromethyl or difluoromethyl; and a compound of formula F-2

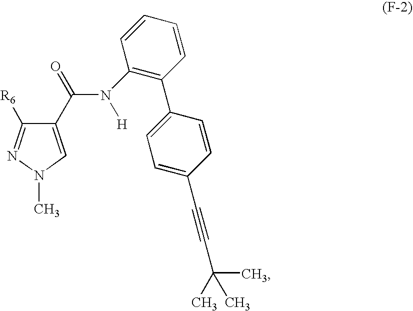

wherein R₆ is trifluoromethyl or difluoromethyl; and a racemic compound of formula F-3 (syn)

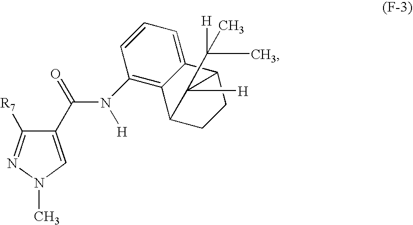

wherein R₇ is trifluoromethyl or difluoromethyl; and a racemic compound of formula F-4 (anti)

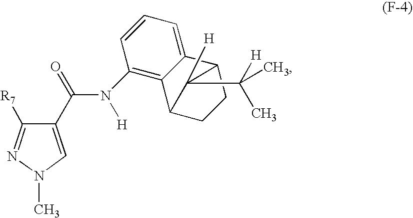

wherein R₇ is trifluoromethyl or difluoromethyl; and a compound of formula F-5

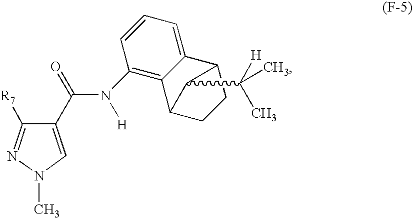

which constitutes an epimeric mixture of the racemic compounds of formulae F-3 (syn) and F-4 (anti), wherein the ratio of the racemic compounds of formula F-3 (syn) to the racemic compounds of formula F-4 (anti) is from 1000:1 to 1:1000 and wherein R₇ is trifluoro-methyl or difluoromethyl; and a compound of formula F-6

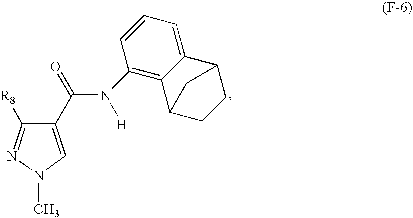

wherein R₈ is trifluoromethyl or difluoromethyl; and a racemic compound of formula F-7 (trans)

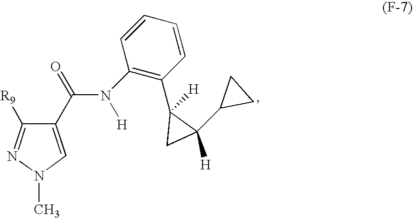

wherein R₉ is trifluoromethyl or difluoromethyl; and a racemic compound of formula F-8 (cis)

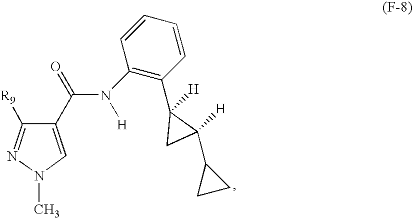

wherein R₉ is trifluoromethyl or difluoromethyl; and a compound of formula F-9

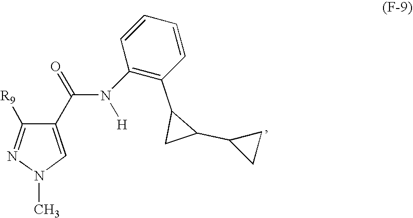

which constitutes a mixture of the racemic compounds of formulae F-7 (trans) and F-8 (cis), wherein the ratio of the racemic compound of formula F-7 (trans) to the racemic compound of formula F-8 (cis) is from 2:1 to 100:1, and wherein R₉ is trifluoromethyl or difluoromethyl;
and a compound of formula F-10

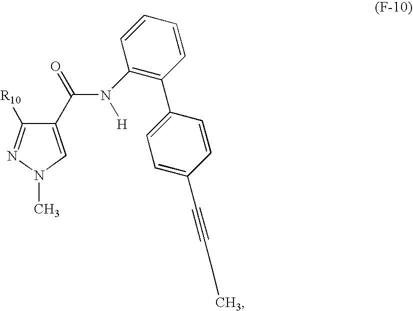

wherein R₁₀ is trifluoromethyl or difluoromethyl; and a racemic compound of formula F-11 (trans)

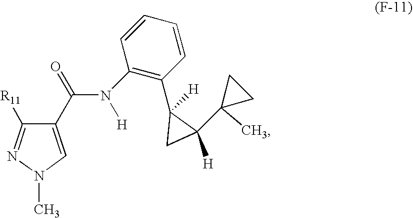

wherein R₁₁ is trifluoromethyl or difluoromethyl; and a racemic compound of formula F-12 (cis)

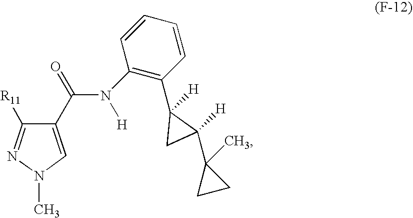

wherein R₁₁ is trifluoromethyl or difluoromethyl; and a compound of formula F-13

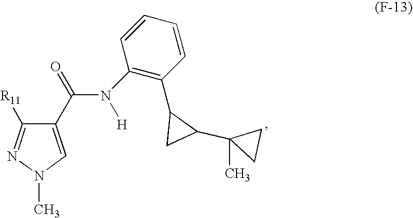

which constitutes a mixture of the racemic compounds of formulae F-11 (trans) and F-12 (cis), and wherein R₁₁ is trifluoromethyl or difluoromethyl; and a compound of formula F-14

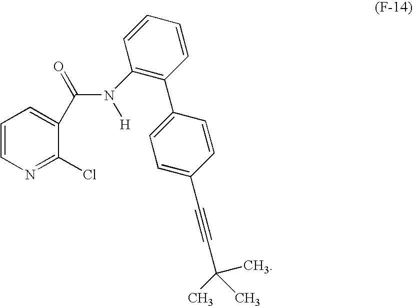

The compounds of formula I are known and are described, for example, in WO 03/015518 or WO 04/067528.

Further pesticidal compositions are preferred which, in addition to comprising adjuvants, consisting of as active ingredients,

a) as component (A), a compound of formula I

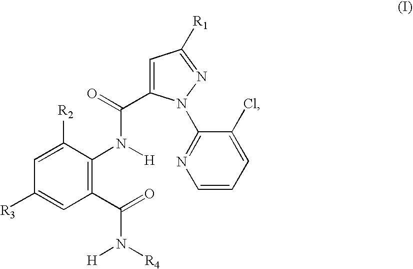

wherein
R₁ is halogen, C₁-C₄haloalkyl or C₁-C₄haloalkoxy;
R₂ is halogen or C₁-C₄alkyl;
R₃ is halogen or cyano; and
R₄ is C₁-C₄alkyl; and

b) as component (B), a synergistically effective amount of at least one active ingredient selected from the group consisting of compounds from the class of azoles, pyrimidinyl carbinols, 2-aminopyrimidines, morpholines, anilinopyrimidines, pyrroles, phenylamides, benzimidazoles, dicarboximides, carboxamides, guanidines, strobilurins, dithiocarbamates, N-halomethylthiotetrahydrophthalimides, copper-containing compounds, nitrophenol derivatives, organo-phosphorus derivatives, a compound of formula F-1

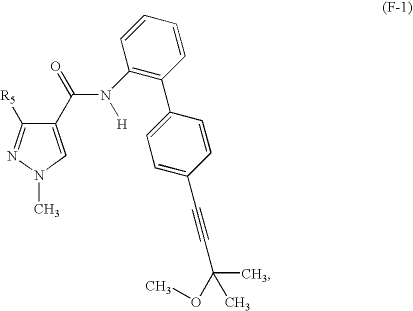

wherein R₅ is trifluoromethyl or difluoromethyl; and a compound of formula F-2

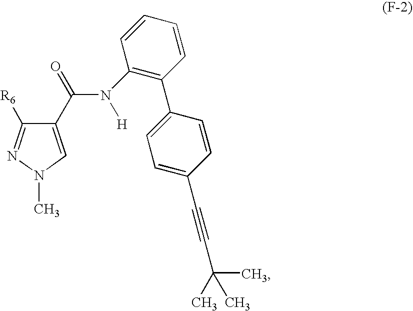

wherein R₆ is trifluoromethyl or difluoromethyl; and a racemic compound of formula F-3 (syn)

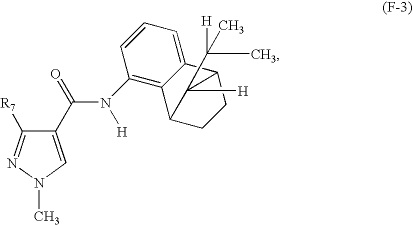

wherein R₇ is trifluoromethyl or difluoromethyl; and a racemic compound of formula F-4 (anti)

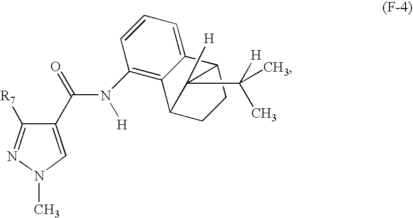

wherein R₇ is trifluoromethyl or difluoromethyl; and a compound of formula F-5

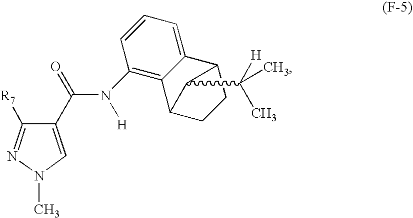

which constitutes an epimeric mixture of the racemic compounds of formulae F-3 (syn) and F-4 (anti), wherein the ratio of the racemic compounds of formula F-3 (syn) to the racemic compounds of formula F-4 (anti) is from 1000:1 to 1:1000 and wherein R₇ is trifluoro-methyl or difluoromethyl; and a compound of formula F-6

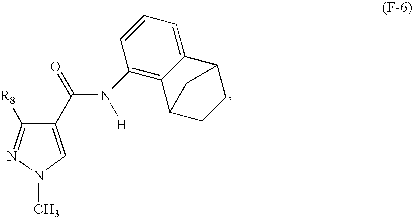

wherein R₈ is trifluoromethyl or difluoromethyl; and a racemic compound of formula F-7 (trans)

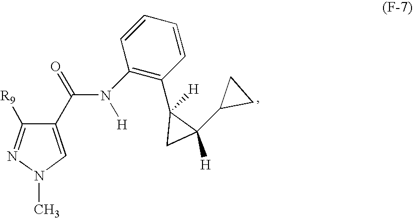

wherein R₉ is trifluoromethyl or difluoromethyl; and a racemic compound of formula F-8 (cis)

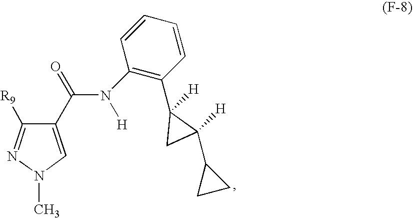

wherein R₉ is trifluoromethyl or difluoromethyl; and a compound of formula F-9

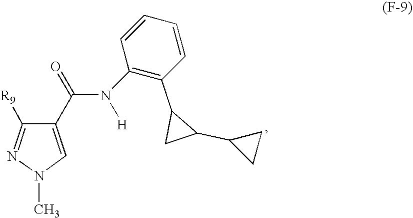

which constitutes a mixture of the racemic compounds of formulae F-7 (trans) and F-8 (cis), wherein the ratio of the racemic compound of formula F-7 (trans) to the racemic compound of formula F-8 (cis) is from 2:1 to 100:1 and wherein R₉ is trifluoromethyl or difluoromethyl; and a compound of formula F-10

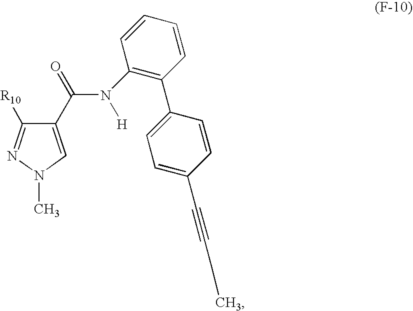

wherein R₁₀ is trifluoromethyl or difluoromethyl; and a racemic compound of formula F-11 (trans)

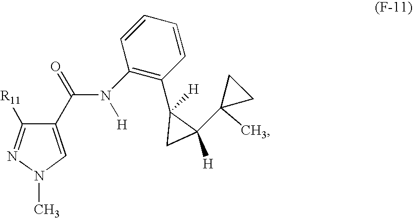

wherein R₁₁ is trifluoromethyl or difluoromethyl; and a racemic compound of formula F-12 (cis)

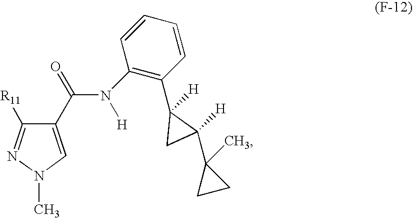

wherein R₁₁ is trifluoromethyl or difluoromethyl; and a compound of formula F-13

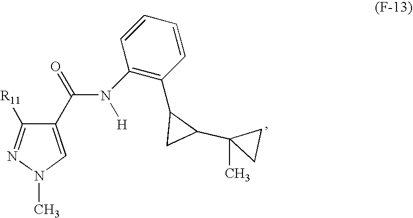

which constitutes a mixture of the racemic compounds of formulae F-11 (trans) and F-12 (cis) and wherein R₁₁ is trifluoromethyl or difluoromethyl; and a compound of formula F-14

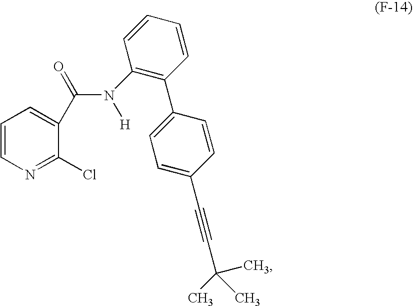

and the compounds acibenzolar-5-methyl, anilazine, benthiavalicarb, blasticidin-S, chinomethionat, chloroneb, chlorothalonil, cyflufenamid, cymoxanil, dichlone, diclocymet, diclomezine, dicloran, diethofencarb, dimethomorph, SYP-L190 (flumorph), dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, IKF-916 (cyazofamid), kasugamycin, methasulfocarb, metrafenone, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide (RH7281) and mandipropamid.

The components (B) are also known and are described, for example, in the following publications:

azaconazole (60207-31-0], bitertanol [70585-36-3], bromuconazole [116255-48-2], cyproconazole [94361-06-5], difenoconazole [119446-68-3], diniconazole [83657-24-3], epoxiconazole [106325-08-0], fenbuconazole [114369-43-6], fluquinconazole [136426-54-5], flusilazole [85509-19-9], flutriafol [76674-21-0], hexaconazole [79983-71-4], imazalil [35554-44-0], imibenconazole [86598-92-7], ipconazole [125225-28-7], metconazole [125116-23-6], myclobutanil [88671-89-0], pefurazoate [101903-30-4], penconazole [66246-88-6], prothioconazole [178928-70-6], pyrifenox [88283-41-4], prochloraz [67747-09-5], propiconazole [60207-90-1], simeconazole [149508-90-7], tebuconazole [107534-96-3], tetraconazole [112281-77-3], triadimefon [43121-43-3], triadimenol [55219-65-3], triflumizole [99387-89-0], triticonazole [131983-72-7], ancymidol [12771-68-5], fenarimol [60168-88-9], nuarimol [63284-71-9], bupirimate [41483-43-6], dimethirimol [5221-53-4], ethirimol [23947-60-6], dodemorph [1593-77-7], fenpropidin [67306-00-7], fenpropimorph [67564-91-4], spiroxamine [118134-30-8], tridemorph [81412-43-3], cyprodinil [121552-61-2], mepanipyrim [110235-47-7], pyrimethanil [53112-28-0], fenpiclonil [74738-17-3], fludioxonil [131341-86-1], benalaxyl [71626-11-4], furalaxyl [57646-30-7], metalaxyl [57837-19-1], R-metalaxyl [70630-17-0], ofurace [58810-48-3], oxadixyl [77732-09-3], benomyl [17804-35-2], carbendazim [10605-21-7], debacarb [62732-91-6], fuberidazole [3878-19-1], thiabendazole [148-79-8], chlozolinate [84332-86-5], dichlozoline [24201-58-9], iprodione [36734-19-7], myclozolin [54864-61-8], procymidone [32809-16-8], vinclozolin [50471-44-8], boscalid [188425-85-6], carboxin [5234-68-4], fenfuram [24691-80-3], flutolanil [66332-96-5], mepronil [55814-41-0], oxycarboxin [5259-88-1], penthiopyrad [183675-82-3], thifluzamide [130000-40-7], guazatine [108173-90-6], dodine [2439-10-3] [112-65-2] (free base), iminoctadine [13516-27-3], azoxystrobin [131860-33-8], dimoxystrobin [149961-52-4], enestroburin {Proc. BCPC, Int. Congr., Glasgow, 2003, 1, 93}, fluoxastrobin [361377-29-9], kresoxim-methyl [143390-89-0], metominostrobin [133408-50-1], trifloxystrobin [141517-21-7], orysastrobin [248593-16-0], picoxystrobin [117428-22-5], pyraclostrobin [175013-18-0], ferbam [14484-64-1], mancozeb [8018-01-7], maneb [12427-38-2], metiram [9006-42-2], propineb [12071-83-9], thiram [137-26-8], zineb [12122-67-7], ziram [137-30-4], captafol [2425-06-1], captan [133-06-2], dichlofluanid [1085-98-9], fluoroimide [41205-21-4], folpet [133-07-3], tolylfluanid [731-27-1], Bordeaux mixture [8011-63-0], copper hydroxide [20427-59-2], copper oxychloride [1332-40-7], copper sulfate [7758-98-7], copper oxide [1317-39-1], mancopper [53988-93-5], oxine-copper [10380-28-6], dinocap [131-72-6], nitrothal-isopropyl [10552-74-6], edifenphos [17109-49-8], iprobenfos [26087-47-8], isoprothiolane [50512-35-1], phosdiphen [36519-00-3], pyrazophos [13457-18-6], tolclofos-methyl [57018-04-9], acibenzolar-S-methyl [135158-54-2], anilazine [101-05-3], benthiavalicarb [413615-35-7], blasticidin-S [2079-00-7], chinomethionat [2439-01-2], chloroneb [2675-77-6], chlorothalonil [1897-45-6], cyflufenamid [180409-60-3], cymoxanil [57966-95-7], dichlone [117-80-6], diclocymet [139920-32-4], diclomezine [62865-36-5], dicloran [99-30-9], diethofencarb [87130-20-9], dimethomorph [110488-70-5], SYP-L190 (flumorph) [211867-47-9], dithianon [3347-22-6], ethaboxam [162650-77-3], etridiazole [2593-15-9], famoxadone [131807-57-3], fenamidone [161326-34-7], fenoxanil [115852-48-7], fentin [668-34-8], ferimzone [89269-64-7], fluazinam [79622-59-6], fluopicolide [239110-15-7], flusulfamide [106917-52-6], fenhexamid [126833-17-8], fosetyl-aluminium [39148-24-8], hymexazol [10004-44-1], iprovalicarb [140923-17-7], IKF-916 (cyazofamid) [120116-88-3], kasugamycin [6980-18-3], methasulfocarb [66952-49-6], metrafenone [220899-03-6], pencycuron [66063-05-6], phthalide [27355-22-2], polyoxins [11113-80-7], probenazole [27605-76-1], propamocarb [25606-41-1], proquinazid [189278-12-4], pyroquilon [57369-32-1], quinoxyfen [124495-18-7], quintozene [82-68-8], sulfur [7704-34-9], tiadinil [223580-51-6], triazoxide [72459-58-6], tricyclazole [41814-78-2], triforine [26644-46-2], validamycin [37248-47-8], zoxamide (RH7281) [156052-68-5], mandipropamid [374726-62-2], the compound of formula F-1

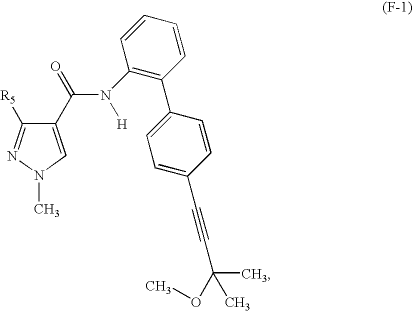

wherein R₅ is trifluoromethyl or difluoromethyl (WO2004/058723); the compound of formula F-2

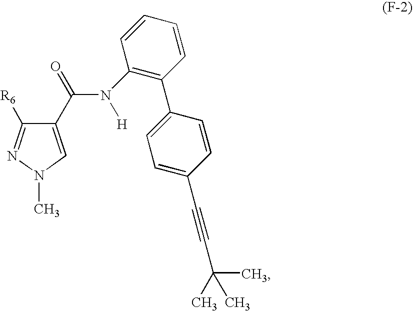

wherein R₆ is trifluoromethyl or difluoromethyl (WO2004/058723);
the racemic compound of formula F-3 (syn)

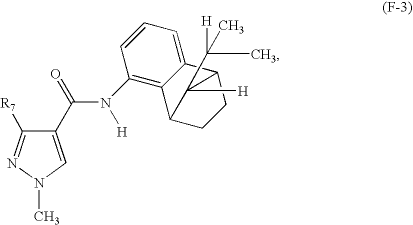

wherein R₇ is trifluoromethyl or difluoromethyl (WO2004/035589);
the racemic compound of formula F-4 (anti)

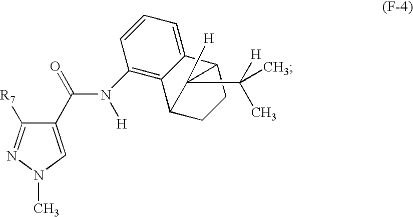

wherein R₇ is trifluoromethyl or difluoromethyl (WO2004/035589); the compound of formula

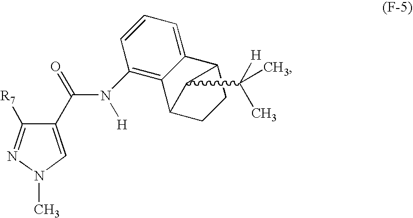

which constitutes an epimeric mixture of the racemic compounds of formulae F-3 (syn) and F-4 (anti), wherein the ratio of the racemic compounds of formula F-3 (syn) to the racemic compounds of formula F-4 (anti) is from 1000:1 to 1:1000 and wherein R₇ is trifluoromethyl or difluoromethyl (WO2004/035589); the compound of formula F-6

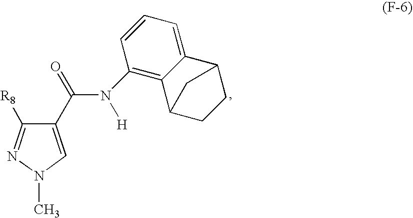

wherein R₈ is trifluoromethyl or difluoromethyl (WO2004/035589); the racemic compound of formula F-7 (trans)

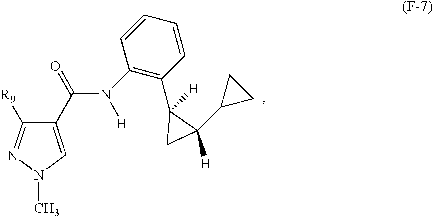

wherein R₉ is trifluoromethyl or difluoromethyl (WO03/074491); the racemic compound of formula F-8 (cis)

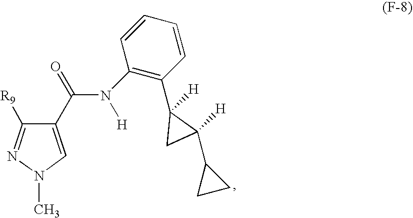

wherein R₉ is trifluoromethyl or difluoromethyl (WO03/074491); the compound of formula F-9

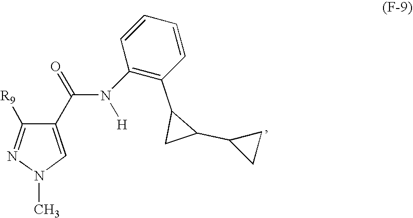

which constitutes a mixture of the racemic compounds of formulae F-7 (trans) and F-8 (cis), wherein the ratio of the racemic compound of formula F-7 (trans) to the racemic compound of formula F-8 (cis) is from 2:1 to 100:1 (WO03/074491) and wherein R₉ is trifluoro-methyl or difluoromethyl;
the compound of formula F-10

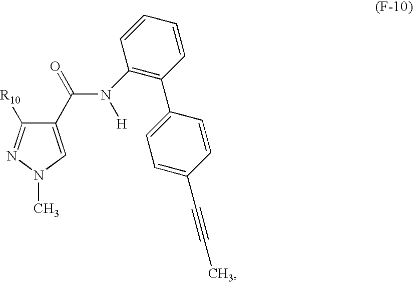

wherein R₁₀ is trifluoromethyl or difluoromethyl (WO2004/058723); the racemic compound of formula F-11 (trans)

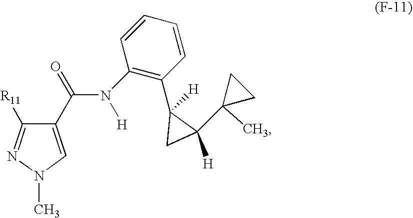

wherein R₁₁ is trifluoromethyl or difluoromethyl (WO03/074491); the racemic compound of formula F-12 (cis)

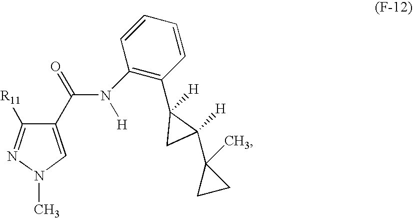

wherein R₁₁ is trifluoromethyl or difluoromethyl (WO03/074491); the compound of formula

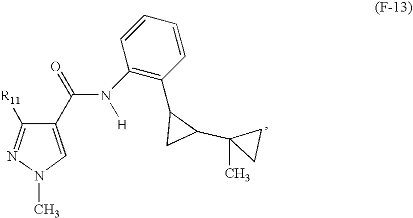

which constitutes a mixture of the racemic compounds of formulae F-11 (trans) and F-12 (cis) and wherein R₁₁ is trifluoromethyl or difluoromethyl (WO03/074491); the compound of formula F-14

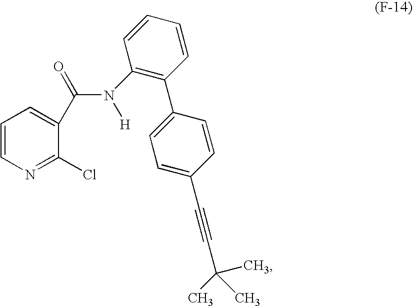

### (WO2004/058723).

The references in square brackets after the active ingredients, for example [3878-19-1], indicate the particular Chemical Abstracts Registry Number.

Especially preferred compositions according to the invention comprise, as active ingredients, the compound of formula A-1 and a compound selected from the compounds (B); or the compound of formula A-2 and a compound selected from the compounds (B);

or the compound of formula A-3 and a compound selected from the compounds (B);
or the compound of formula A-4 and a compound selected from the compounds (B);
or the compound of formula A-5 and a compound selected from the compounds (B);
or the compound of formula A-6 and a compound selected from the compounds (B);
or the compound of formula A-7 and a compound selected from the compounds (B);
or the compound of formula A-8 and a compound selected from the compounds (B);
or the compound of formula A-9 and a compound selected from the compounds (B);
or the compound of formula A-10 and a compound selected from the compounds (B);
or the compound of formula A-11 and a compound selected from the compounds (B);
or the compound of formula A-12 and a compound selected from the compounds (B);
or the compound of formula A-13 and a compound selected from the compounds (B);
or the compound of formula A-14 and a compound selected from the compounds (B);
or the compound of formula A-15 and a compound selected from the compounds (B);
or the compound of formula A-16 and a compound selected from the compounds (B);
or the compound of formula A-17 and a compound selected from the compounds (B);
or the compound of formula A-18 and a compound selected from the compounds (B);
or the compound of formula A-19 and a compound selected from the compounds (B);
or the compound of formula A-20 and a compound selected from the compounds (B);
or the compound of formula A-21 and a compound selected from the compounds (B);
or the compound of formula A-22 and a compound selected from the compounds (B);
or the compound of formula A-23 and a compound selected from the compounds (B);
or the compound of formula A-24 and a compound selected from the compounds (B);
or the compound of formula A-25 and a compound selected from the compounds (B);
or the compound of formula A-26 and a compound selected from the compounds (B).

Very especially preferred compositions according to the invention comprise, as active ingredients,

a compound of formula A-1 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-2 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-3 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-4 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-5 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-6 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-7 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-8 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-9 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-10 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-11 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-12 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-13 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-14 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-15 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-16 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-17 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-18 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-19 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-20 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-21 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-22 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-23 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-24 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-25 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-26 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil.

Especially preferred compositions according to the invention in addition to comprising adjuvants, consist of as active ingredients, the compound of formula A-1 and at least one compound selected from the compounds (B); or the compound of formula A-2 and at least one compound selected from the compounds (B);

or the compound of formula A-3 and at least one compound selected from the compounds (B);
or the compound of formula A-4 and at least one compound selected from the compounds (B);
or the compound of formula A-5 and at least one compound selected from the compounds (B);
or the compound of formula A-6 and at least one compound selected from the compounds (B);
or the compound of formula A-7 and at least one compound selected from the compounds (B);
or the compound of formula A-8 and at least one compound selected from the compounds (B);
or the compound of formula A-9 and at least one compound selected from the compounds (B);
or the compound of formula A-10 and at least one compound selected from the compounds (B);
or the compound of formula A-11 and at least one compound selected from the compounds (B);
or the compound of formula A-12 and at least one compound selected from the compounds (B);
or the compound of formula A-13 and at least one compound selected from the compounds (B);
or the compound of formula A-14 and at least one compound selected from the compounds (B);
or the compound of formula A-15 and at least one compound selected from the compounds (B);
or the compound of formula A-16 and at least one compound selected from the compounds (B);
or the compound of formula A-17 and at least one compound selected from the compounds (B);
or the compound of formula A-18 and at least one compound selected from the compounds (B);
or the compound of formula A-19 and at least one compound selected from the compounds (B);
or the compound of formula A-20 and at least one compound selected from the compounds (B);
or the compound of formula A-21 and at least one compound selected from the compounds (B);
or the compound of formula A-22 and at least one compound selected from the compounds (B);
or the compound of formula A-23 and at least one compound selected from the compounds (B);
or the compound of formula A-24 and at least one compound selected from the compounds (B);
or the compound of formula A-25 and at least one compound selected from the compounds (B);
or the compound of formula A-26 and at least one compound selected from the compounds (B).

Very especially preferred compositions according to the invention, in addition to comprising adjuvants, consist of, as active ingredients,

a compound of formula A-1 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-2 and a compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-3 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-4 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-5 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-6 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-7 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-8 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-9 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-10 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-11 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-12 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-13 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-14 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-15 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-16 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-17 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-18 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-19 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-20 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-21 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-22 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-23 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-24 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-25 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil; or
a compound of formula A-26 and at least one compound selected from the compounds azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil.

(Z) Further preferred embodiments of the present invention include compositions which, in addition to comprising adjuvants, consist of, as active ingredients,

A compound of formula A-1 and pyroquilon; or
A compound of formula A-2 and pyroquilon; or
A compound of formula A-3 and pyroquilon; or
A compound of formula A-4 and pyroquilon; or
A compound of formula A-5 and pyroquilon; or
A compound of formula A-6 and pyroquilon; or
A compound of formula A-7 and pyroquilon; or
A compound of formula A-8 and pyroquilon; or
A compound of formula A-9 and pyroquilon; or
A compound of formula A-10 and pyroquilon; or
A compound of formula A-11 and pyroquilon; or
A compound of formula A-12 and pyroquilon; or
A compound of formula A-13 and pyroquilon; or
A compound of formula A-14 and pyroquilon; or
A compound of formula A-15 and pyroquilon; or
A compound of formula A-16 and pyroquilon; or
A compound of formula A-17 and pyroquilon; or
A compound of formula A-18 and pyroquilon; or
A compound of formula A-19 and pyroquilon; or
A compound of formula A-20 and pyroquilon; or
A compound of formula A-21 and pyroquilon; or
A compound of formula A-22 and pyroquilon; or
A compound of formula A-23 and pyroquilon; or
A compound of formula A-24 and pyroquilon; or
A compound of formula A-25 and pyroquilon; or
A compound of formula A-26 and pyroquilon; or
A compound of formula A-1 and cyproconazole; or
A compound of formula A-2 and cyproconazole; or
A compound of formula A-3 and cyproconazole; or
A compound of formula A-4 and cyproconazole; or
A compound of formula A-5 and cyproconazole; or
A compound of formula A-6 and cyproconazole; or
A compound of formula A-7 and cyproconazole; or
A compound of formula A-8 and cyproconazole; or
A compound of formula A-9 and cyproconazole; or
A compound of formula A-10 and cyproconazole; or
A compound of formula A-11 and cyproconazole; or
A compound of formula A-12 and cyproconazole; or
A compound of formula A-13 and cyproconazole; or
A compound of formula A-14 and cyproconazole; or
A compound of formula A-15 and cyproconazole; or
A compound of formula A-16 and cyproconazole; or
A compound of formula A-17 and cyproconazole; or
A compound of formula A-18 and cyproconazole; or
A compound of formula A-19 and cyproconazole; or
A compound of formula A-20 and cyproconazole; or
A compound of formula A-21 and cyproconazole; or
A compound of formula A-22 and cyproconazole; or
A compound of formula A-23 and cyproconazole; or
A compound of formula A-24 and cyproconazole; or
A compound of formula A-25 and cyproconazole; or
A compound of formula A-26 and cyproconazole; or
A compound of formula A-1 and azoxystrobin; or
A compound of formula A-2 and azoxystrobin; or
A compound of formula A-3 and azoxystrobin; or
A compound of formula A-4 and azoxystrobin; or
A compound of formula A-5 and azoxystrobin; or
A compound of formula A-6 and azoxystrobin; or
A compound of formula A-7 and azoxystrobin; or
A compound of formula A-8 and azoxystrobin; or
A compound of formula A-9 and azoxystrobin; or
A compound of formula A-10 and azoxystrobin; or
A compound of formula A-11 and azoxystrobin; or
A compound of formula A-12 and azoxystrobin; or
A compound of formula A-13 and azoxystrobin; or
A compound of formula A-14 and azoxystrobin; or
A compound of formula A-15 and azoxystrobin; or
A compound of formula A-16 and azoxystrobin; or
A compound of formula A-17 and azoxystrobin; or
A compound of formula A-18 and azoxystrobin; or
A compound of formula A-19 and azoxystrobin; or
A compound of formula A-20 and azoxystrobin; or
A compound of formula A-21 and azoxystrobin; or
A compound of formula A-22 and azoxystrobin; or
A compound of formula A-23 and azoxystrobin; or
A compound of formula A-24 and azoxystrobin; or
A compound of formula A-25 and azoxystrobin; or
A compound of formula A-26 and azoxystrobin.

The above mentioned further preferred embodiments (Z) of the present invention can additionally contain as a further active ingredient (C) an insecticide selected from the group consisting of

thiamethoxam (792), abamectin (1), emamectin (291), lambda-cyhalothrin (198), cyhalothrin (196), and tefluthrin (769).

The compounds (C) are mentioned in “The Pesticide Manual” [The Pesticide Manual—A World Compendium; Thirteenth Edition; Editor: C. D. S. Tomlin; The British Crop Protection Council], they are described therein under the entry number given in round brackets hereinabove for the particular compound (B); for example, the compound “abamectin” is described under entry number (1).

It has now been found, surprisingly, that the active ingredient mixture according to the invention not only brings about the additive enhancement of the spectrum of action with respect to the pests and fungi to be controlled that was in principle to be expected but achieves a synergistic effect which extends the range of action of the compound (A) and of the compound (B) in two ways. Firstly, the rates of application of the compound (A) and of the compound (B) are lowered whilst the action remains equally good. Secondly, the active ingredient mixture still achieves a high degree of pest and fungal control even where the two individual compounds have become totally ineffective in such a low application rate range. This allows, on the one hand, a substantial broadening of the spectrum of pests and fungi that can be controlled and, on the other hand, increased safety in use.

However, besides the actual synergistic action with respect to pesticidal activity, the pesticidal compositions according to the invention also have further surprising advantages which can also be described, in a wider sense, as synergistic activity. For example, pests can be controlled which cannot be controlled, or cannot be controlled with sufficient effectiveness, using an individual compound (A) or an individual compound (B). The active ingredient mixture according to the invention is also better tolerated by plants, that is to say, for example, it exhibits reduced phytotoxicity, compared to the individual compounds (A) and (B). Also, for example, insects can be controlled in their different development stages, which is not the case with some of the individual compounds (A) and (B), because those individual compounds can be used, for example, only as adulticides or only as larvicides against highly specific larval stages. Moreover, the pesticidal compositions according to the invention in some cases exhibit better behaviour during their production, for example during grinding or mixing, during their storage or during their use.

The compositions according to the invention exhibit, in the area of pest control, valuable preventive and/or curative activity with a very advantageous biocidal spectrum, even at low rates of concentration, while being well tolerated by warm-blooded organisms, fish and plants. The compositions according to the invention are effective especially against all or individual development stages of normally sensitive animal pests, but also of resistant animal pests, such as insects and representatives of the order Acarina. The insecticidal or acaricidal activity of the compositions according to the invention may manifest itself directly, i.e. in the mortality of the pests, which occurs immediately or only after some time, for example during moulting, or indirectly, for example in reduced oviposition and/or hatching rate, good activity corresponding to a mortality of at least 50 to 60%. For example, by appropriate selection of the compound (B), it is also possible to achieve in addition, for example, an algicidal, anthelmintic, avicidal, bactericidal, molluscicidal, nematicidal, plant-activating, rodenticidal or virucidal action of the compositions according to the invention.

The mentioned animal pests include, for example:

of the order Acarina, for example,
Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.;
of the order Anoplura, for example,

### Haematopinus spp., Linognathus spp., Pediculus spp., Pemphigus spp. and Phylloxera spp.;

of the order Coleoptera, for example
Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.;
of the order Diptera, for example,
Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.;
of the order Heteroptera, for example,
Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.;
of the order Homoptera, for example,
Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma lanigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri;
of the order Hymenoptera, for example,
Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.;
of the order Isoptera, for example,

### Reticulitermes spp.;

of the order Lepidoptera, for example,
Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.;
of the order Mallophaga, for example,

### Damalinea spp. and Trichodectes spp.;

of the order Orthoptera, for example,
Blatta spp., Blattella spp., Gryllotalpa spp., Leucophaea maderae, Locusta spp., Periplaneta spp. and Schistocerca spp.;
of the order Psocoptera, for example,

### Liposcelis spp.;

of the order Siphonaptera, for example,
Ceratophyllus spp., Ctenocephalides spp. and Xenopsylla cheopis;
of the order Thysanoptera, for example,
Frankliniella spp., Hercinothrips spp., Scirtothrips aurantii, Taeniothrips spp., Thrips palmi and Thrips tabaci; and
of the order Thysanura, for example,
Lepisma saccharina.

Nematicidal action can be exhibited, for example, with respect to the following pests of the class Nematoda:

root knot nematodes, cyst-forming nematodes, stem nematodes or leaf nematodes; pests of the families Filariidae or Setariidae; or
pests of the genera Ancylostoma, especially Ancylostoma caninum, Anguina, Aphelenchoides, Ascaridia, Ascaris, Bunostumum, Capillaria, Chabertia, Cooperia, Dictyocaulus, Dirofilaria, especially Dirofilaria immitis, Ditylenchus, Globodera, especially Globodera rostochiensis, Haemonchus, Heterakis, Heterodera, especially Heterodera avenae, Heterodera glycines, Heterodera schachtii or Heterodera trifolii, Longidorus, Meloidogyne, especially Meloidogyne incognita or Meloidogyne javanica, Nematodirus, Oesophagostonum, Ostertagia, Oxyuris, Parascaris, Pratylenchus, especially Pratylenchus neglectans or Pratylenchus penetrans, Radopholus, especially Radopholus similis, Strongyloides, Strongylus, Toxascaris, Toxocara, especially Toxocara canis, Trichodorus, Trichonema, Trichostrongylus, Trichuris, especially Trichuris vulpis, Tylenchulus, especially Tylenchulus semipenetrans, Uncinaria or Xiphinema.

The compositions according to the invention can be used to control, i.e. to inhibit or destroy, pests of the mentioned type occurring especially on plants, more especially on useful plants and ornamentals in agriculture, in horticulture and in forestry, or on parts of such plants, such as the fruits, blossoms, leaves, stems, tubers or roots, while in some cases parts of plants that grow later are still protected against those pests.

The compositions according to the invention are effective, for example, against phytopathogenic fungi belonging to the following classes: Fungi imperfecti (especially Botrytis, Pyricularia, Helminthosporium, Fusarium, Septoria, Cercospora, Cercosporella and Alternaria); basidiomycetes (for example, Rhizoctonia, Hemileia, Puccinia); ascomycetes (for example, Venturia and Erysiphe, Podosphaera, Monilinia, Uncinula), but especially against oomycetes (for example, Phytophthora, Peronospora, Bremia, Pythium, Plasmopara).

Target crops are especially cereals, e.g. wheat, barley, rye, oats, rice, maize and sorghum; beet, such as sugar beet and fodder beet; fruit, e.g. pomes, stone fruit and soft fruit, such as apples, pears, plums, peaches, almonds, cherries and berries, e.g. strawberries, raspberries and blackberries; leguminous plants, such as beans, lentils, peas and soybeans; oil plants, such as rape, mustard, poppy, olives, sunflowers, coconut, castor oil, cocoa and groundnuts; cucurbitaceae, such as marrows, cucumbers and melons; fibre plants, such as cotton, flax, hemp and jute; citrus fruits, such as oranges, lemons, grapefruit and mandarins; vegetables, such as spinach, lettuce, asparagus, cabbages, carrots, onions, tomatoes, potatoes and paprika; lauraceae, such as avocado, cinnamon and camphor; and tobacco, nuts, coffee, aubergines, sugar cane, tea, pepper, vines, hops, bananas, natural rubber plants and ornamentals.

The target crops may be crops of conventional plants or crops of genetically modified plants (“GM plants” or “GMOs”).

The compositions according to the invention are therefore also suitable for use in herbicide-resistant, pest-resistant and/or fungus-resistant transgenic crops of useful plants, especially cereals, cotton, soybeans, sugar beet, sugar cane, plantation crops (e.g. citrus fruits, coffee, bananas), rape, maize and rice.

Herbicide-resistant crops are to be understood as including those that have been made tolerant to herbicides or classes of herbicides (e.g. ALS-, GS-, EPSPS-, PPO- and HPPD-inhibitors) by means of conventional breeding or genetic engineering methods. An example of a crop that has been made tolerant by conventional breeding methods to, for example, imidazolinones such as imazamox is Clearfield® summer rape (canola). Examples of crops made tolerant to herbicides by genetic engineering methods are maize varieties resistant to, for example, glyphosate or glufosinate, which are commercially available under the trade names RoundupReady® and LibertyLink®, respectively.

In the context of the present invention, pest-resistant and/or fungus-resistant transgenic useful plants are expressly understood to include those useful plants which, in addition to having the pest resistance and/or fungus resistance, also have herbicide tolerance. Among the group of herbicide-tolerant useful plants preference is given, in accordance with the invention, to useful plants having tolerance with respect to glyphosate, glufosinate-ammonium, ALS (acetolactate synthase) inhibitors, such as sulfonylureas, e.g. primisulfuron, prosulfuron and trifloxysulfuron, or bromoxynil, such as, for example, Bt11 maize or Herculex I® maize.

Pest-resistant transgenic crop plants are to be understood in the context of the present invention as being plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, e.g. insecticidal proteins from Bacillus cereus or Bacillus popliae; or insecticidal proteins from Bacillus thuringiensis, such as δ-endotoxins, e.g. CryIA(b), CryIA(c), CryIF, CryIF(a2), CryIIA(b), CryIIIA, CryIIIB(b1) or Cry9c, or vegetative insecticidal proteins (VIP), e.g. VIP1, VIP2, VIP3 or VIP3A; or insecticidal proteins of bacteria that colonise nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins; plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroid-oxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example CryIA(b), CryIA(c), CryIF, CryIF(a2), CryIIA(b), CryIIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example of a truncated toxin is a truncated CryIA(b), which is expressed in Bt11 maize of Syngenta Seeds SAS, as described hereinbelow. In the case of modified toxins, one or more amino acids of the naturally occurring toxin is/are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 03/018810).

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the production of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants provides the plants with tolerance to harmful insects. Such insects can occur in any taxonomic group of insects, but are especially commonly found in beetles (Coleoptera), two-winged insects (Diptera) and butterflies (Lepidoptera).

The following harmful insects from different taxonomic groups are especially common in maize crops:

Ostrinia nubilalis, European corn borer

Agrotis ipsilon, black cutworm

Helicoverpa zea, corn earworm

Spodoptera frugiperda, fall armyworm

Diatraea grandiosella, southwestern corn borer

Elasmopalpus lignosellus, lesser cornstalk borer

Diatraea saccharalis, sugarcane borer

Diabrotica virgifera virgifera, western corn rootworm

Diabrotica longicomis barberi, northern corn rootworm

Diabrotica undecimpunctata howardi, southern corn rootworm

Melanotus spp., wireworms

Cyclocephala borealis, northern masked chafer (white grub)

Cyclocephala immaculata, southern masked chafer (white grub)

Popillia japonica, Japanese beetle

Chaetocnema pulicaria, corn flea beetle

Sphenophorus maidis, maize billbug

Rhopalosiphum maidis, corn leaf aphid

Anuraphis maidiradicis, corn root aphid

Blissus leacopterus leucopterus, chinch bug

Melanoplus femurrubrum, red-legged grasshopper

Melanoplus sanguinipes, migratory grasshopper

Hylemya platura, seedcorn maggot

Agromyza parvicomis, corn blotch leafminer

Anaphothrips obscurus, grass thrips

Solenopsis milesta, thief ant

Tetranychus urticae, two-spotted spider mite

Transgenic plants containing one or more genes that code for an insecticidal resistance and express one or more toxins are known and some of them are commercially available. Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricin N-acetyltransferase (PAT) to achieve tolerance to the herbicide glufosinate ammonium); NuCOTN 33B® (cotton variety that expresses a CryIA(c) toxin); Boligard I® (cotton variety that expresses a CryIA(c) toxin); Boligard 10 (cotton variety that expresses a CryIA(c) and a CryIIA(b) toxin); VIPCOT® (cotton variety that expresses a VIP toxin); NewLeaf® (potato variety that expresses a CryIIA toxin); NatureGard® and Protecta®.

Further examples of such transgenic crops are:

1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Bt11 maize also transgenically expresses the enzyme PAT to achieve tolerance to the herbicide glufosinate ammonium.

2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.

3. MIR604Maize from Syngenta Seeds SAS, Chemin de l'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.

4. MON 863 Maize from Monsanto Europe S.A. 270-272 Avenue de Tervuren, B-1150 Brussels, Belgium, registration number C/DE/02/9. MON 863 expresses a CryIIB(b1) toxin and has resistance to certain Coleoptera insects.

5. IPC 531 Cotton from Monsanto Europe S.A. 270-272 Avenue de Tervuren, B-1150 Brussels, Belgium, registration number C/ES/96/02.

6.1507 Maize from Pioneer Overseas Corporation, Avenue Tedesco, 7 B-1160 Brussels, Belgium, registration number C/NU00/10. Genetically modified maize for the expression of the protein Cry1F for achieving resistance to certain Lepidoptera insects and of the PAT protein for achieving tolerance to the herbicide glufosinate ammonium.

7. NK603×MON 810 Maize from Monsanto Europe S.A. 270-272 Avenue de Tervuren, B-1150 Brussels, Belgium, registration number C/GB/O₂/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, including the European corn borer.

Transgenic crops of insect-resistant plants are also described in BATS (Zentrum für Biosicherheit und Nachhaltigkeit, Zentrum BATS, Clarastrasse 13, 4058 Basel, Switzerland) Report 2003, (http://bats.ch).

In the context of the present invention, fungus-resistant transgenic crop plants are to be understood as being those which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818 and EP-A-0 353 191. The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906). Further areas of use of the compositions according to the invention are the protection of stored goods and storerooms and the protection of raw materials, such as wood, textiles, floor coverings or buildings, and also in the hygiene sector, especially the protection of humans, domestic animals and productive livestock against pests of the mentioned type.

In the hygiene sector, the compositions according to the invention are active against ectoparasites such as hard ticks, soft ticks, mange mites, harvest mites, flies (biting and licking), parasitic fly larvae, lice, hair lice, bird lice and fleas.

### Examples of Such Parasites are:

Of the order Anoplurida: Haematopinus spp., Linognathus spp., Pediculus spp. and Phtirus spp., Solenopotes spp.

Of the order Mallophagida: Trimenopon spp., Menopon spp., Trinoton spp., Bovicola spp., Werneckiella spp., Lepikentron spp., Damalina spp., Trichodectes spp. and Felicola spp.

Of the order Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp. and Melophagus spp.

Of the order Siphonapterida, for example Pulex spp., Ctenocephalides spp., Xenopsylla spp., Ceratophyllus spp.

Of the order Heteropterida, for example Cimex spp., Triatoma spp., Rhodnius spp., Panstrongylus spp.

Of the order Blattarida, for example Blatta orientalis, Periplaneta americana, Blattelagermanica and Supella spp.

Of the subclass Acaria (Acarida) and the orders Meta- and Meso-stigmata, for example Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp. and Varroa spp.

Of the orders Actinedida (Prostigmata) and Acaridida (Astigmata), for example Acarapis spp., Cheyletiella spp., Ornithocheyletia spp., Myobia spp., Psorergatesspp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp. and Laminosioptes spp.

The compositions according to the invention are also suitable for protecting against insect infestation in the case of materials such as wood, textiles, plastics, adhesives, glues, paints, paper and card, leather, floor coverings and buildings.

The compositions according to the invention can be used, for example, against the following pests: beetles such as Hylotrupes bajulus, Chlorophorus pilosis, Anobium punctatum, Xestobium rufovillosum, Ptilinuspecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthesrugicollis, Xyleborus spec., Tryptodendron spec., Apate monachus, Bostrychus capucins, Heterobostrychus brunneus, Sinoxylon spec. and Dinoderus minutus, and also hymenopterans such as Sirex juvencus, Urocerus gigas, Urocerus gigas taignus and Urocerus augur, and termites such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis and Coptotermes formosanus, and bristletails such as Lepisma saccharina.

The compositions according to the invention are, for example, emulsifiable concentrates, suspension concentrates, directly sprayable or dilutable solutions, coatable pastes, dilute emulsions, powders for application in sprays, soluble powders, dispersible powders, wettable powders, dusts, granules or encapsulations in polymer substances, comprising one of the active ingredient mixtures according to the invention, the type of formulation being chosen in accordance with the intended objectives and prevailing circumstances.

The active ingredient mixture is used in those compositions in pure form, a solid active ingredient mixture, for example, in a specific particle size, or preferably together with—at least—one of the adjuvants customary in formulation technology, such as extenders, for example solvents or solid carriers, or surface-active compounds (surfactants). The composition according to the invention comprises an active ingredient (A) and active ingredients (B) in any mixing ratio, usually with an excess of one component over the other. In general, the mixing ratios (weight ratio) between the active ingredient (A) and the mixing partners (B) are from 1:2000 to 2000:1, especially from 200:1 to 1:200.

Suitable solvents are, for example: optionally partially hydrogenated aromatic hydrocarbons, preferably the fractions of alkylbenzenes containing 8 to 12 carbon atoms, such as xylene mixtures, alkylated naphthalenes or tetrahydronaphthalene, aliphatic or cycloaliphatic hydrocarbons, such as paraffins or cyclohexane, alcohols, such as ethanol, propanol or butanol, glycols and their ethers and esters, such as propylene glycol, dipropylene glycol ether, ethylene glycol or ethylene glycol monomethyl or monoethyl ether, ketones, such as cyclohexanone, isophorone or diacetone alcohol, strongly polar solvents, such as N-methyl-pyrrolid-2-one, dimethyl sulfoxide or N,N-dimethylformamide, water, vegetable oils or epoxidised vegetable oils, such as rapeseed oil, castor oil, coconut oil or soybean oil or epoxidised rapeseed oil, castor oil, coconut oil or soybean oil, and silicone oils.

The solid carriers used, e.g. for dusts and dispersible powders, are normally natural mineral fillers such as calcite, talcum, kaolin, montmorillonite or aftapulgite. In order to improve the physical properties it is also possible to add highly dispersed silicic acids or highly dispersed absorbent polymers. Suitable granulated adsorptive carriers are porous types, such as pumice, broken brick, sepiolite or bentonite; and suitable nonsorbent carriers are calcite or sand. In addition, a great number of granulated materials of inorganic or organic nature can be used, especially dolomite or pulverised plant residues.

Depending on the nature of the active ingredient mixture to be formulated, suitable surface-active compounds are non-ionic, cationic and/or anionic surfactants or mixtures of surfactants having good emulsifying, dispersing and wetting properties. The surfactants listed below are to be regarded merely as examples; many more surfactants customarily employed in formulation technology and suitable for use according to the invention are described in the relevant literature.

Non-ionic surfactants are preferably polyglycol ether derivatives of aliphatic or cycloaliphatic alcohols, saturated or unsaturated fatty acids or alkylphenols, said derivatives containing about 3 to about 30 glycol ether groups and about 8 to about 20 carbon atoms in the (cyclo)aliphatic hydrocarbon moiety and about 6 to about 18 carbon atoms in the alkyl moiety of the alkylphenols. Further suitable non-ionic surfactants are water-soluble adducts of polyethylene oxide with polypropylene glycol, ethylenediaminopolypropylene glycol or alkylpolypropylene glycol containing 1 to about 10 carbon atoms in the alkyl chain, which adducts contain about 20 to about 250 ethylene glycol ether groups and about 10 to about 100 propylene glycol ether groups. These compounds usually contain 1 to about 5 ethylene glycol units per propylene glycol unit. Examples of non-ionic surfactants are nonylphenol polyethoxyethanol, castor oil polyglycol ethers, polypropylene glycol/polyethylene oxide adducts, tributylphenoxypolyethoxyethanol, polyethylene glycol and octylphenoxypolyethoxyethanol. Fatty acid esters of polyoxyethylene sorbitan, e.g. polyoxyethylene sorbitan trioleate, are also suitable.

Cationic surfactants are preferably quaternary ammonium salts which generally contain, as substituent, at least one alkyl radical containing about 8 to about 20 carbon atoms and, as further substituents, (unsubstituted or halogenated) lower alkyl or hydroxy-lower alkyl or benzyl radicals. The salts are preferably in the form of halides, methyl sulfates or ethyl sulfates. Examples are stearyltrimethylammonium chloride and benzyl bis(2-chloroethyl)-ethylammonium bromide.

Suitable anionic surfactants are, for example, water-soluble soaps and water-soluble synthetic surface-active compounds. Suitable soaps are, for example, the alkali metal salts, alkaline earth metal salts or (unsubstituted or substituted) ammonium salts of fatty acids containing about 10 to about 22 carbon atoms, e.g. the sodium or potassium salts of oleic or stearic acid or of natural fatty acid mixtures which can be obtained e.g. from coconut oil or tall oil; mention may also be made of fatty acid methyltaurin salts. More frequently, however, synthetic surfactants are used, especially fatty sulfonates, fatty sulfates, sulfonated benzimidazole derivatives or alkylarylsulfonates. The fatty sulfonates and fatty sulfates are usually in the form of alkali metal salts, alkaline earth metal salts or (unsubstituted or substituted) ammonium salts and generally contain an alkyl radical containing about 8 to about 22 carbon atoms, which also includes the alkyl moiety of acyl radicals; there may be mentioned by way of example the sodium or calcium salts of lignosulfonic acid, of dodecyl sulfate or of a mixture of fatty alcohol sulfates obtained from natural fatty acids. These compounds also comprise the salts of sulfated and sulfonated fatty alcohol/ethylene oxide adducts. The sulfonated benzimidazole derivatives preferably contain 2 sulfonic acid groups and one fatty acid radical containing about 8 to about 22 carbon atoms. Examples of alkylarylsulfonates are the sodium, calcium or triethanolammonium salts of dodecylbenzene-sulfonic acid, dibutylnaphthalenesulfonic acid or of a condensate of naphthalenesulfonic acid and formaldehyde. Also suitable are corresponding phosphates, e.g. salts of the phosphoric acid ester of an adduct of p-nonylphenol with 4 to 14 mol of ethylene oxide, or phospholipids.

The compositions according to the invention usually comprise 0.1 to 99%, especially 0.1 to 95%, of an active ingredient mixture according to the invention and 1 to 99.9%, especially 5 to 99.9%, of—at least—one solid or liquid adjuvant, it generally being possible for 0 to 25%, preferably 0.1 to 20%, of the composition to be surfactants (in each case percentages are by weight). Whereas commercial products in the form of concentrates will usually be preferred, the end user will normally employ dilute formulations, which have considerably lower active ingredient concentrations.

Preferred formulations have especially the following compositions (%=percent by weight):

| | |
|---|---|
| Emulsifiable concentrates: | |
| active ingredient mixture: | 1 to 90%, preferably 5 to 20% |
| surfactant: | 1 to 30%, preferably 10 to 20% |
| solvent: | 5 to 98%, preferably 70 to 85% |
| Dusts: | |
| active ingredient mixture: | 0.1 to 10%, preferably 0.1 to 1% |
| solid carrier: | 99.9 to 90%, preferably 99.9 to 99% |
| Suspension concentrates: | |
| active ingredient mixture: | 5 to 75%, preferably 10 to 50% |
| water: | 94 to 24%, preferably 88 to 30% |
| surfactant: | 1 to 40%, preferably 2 to 30% |
| Wettable powders: | |
| active ingredient mixture: | 0.5 to 90%, preferably 1 to 80% |
| surfactant: | 0.5 to 20%, preferably 1 to 15% |
| solid carrier: | 5 to 99%, preferably 15 to 98% |
| Granules: | |
| active ingredient mixture: | 0.5 to 30%, preferably 3 to 15% |
| solid carrier: | 99.5 to 70%, preferably 97 to 85% |

The compositions according to the invention may also comprise further solid or liquid adjuvants, such as stabilisers, e.g. vegetable oils or epoxidised vegetable oils (e.g. epoxidised coconut oil, rapeseed oil or soybean oil), antifoams, e.g. silicone oil, preservatives, viscosity regulators, binders, tackifiers or fertilisers.

The compositions according to the invention are prepared in a manner known per se, in the absence of adjuvants, for example by grinding, sieving and/or compressing a solid active ingredient mixture, and in the presence of at least one adjuvant, for example by intimately mixing and/or grinding the active ingredient mixture with the adjuvant(s). The invention relates also to those processes for the preparation of the compositions and to the use of the compounds (A) and compounds (B) in the preparation of those compositions.

The invention relates also to the methods of application of the compositions, i.e. the methods of controlling pests and fungi of the mentioned type, such as spraying, atomising, dusting, coating, dressing, scattering or pouring, which are selected in accordance with the intended objectives and prevailing circumstances, and to the use of the compositions for controlling pests of the mentioned type. Typical rates of concentration are from 0.1 to 1000 ppm, preferably from 0.1 to 500 ppm, of active ingredient mixture. The rates of application per hectare are generally from 1 to 2000 g of active ingredient mixture per hectare, especially from 10 to 1000 g/ha, preferably from 20 to 600 g/ha. The rate of application may vary within wide limits and depends on the nature of the soil, the method of application (foliar application; seed dressing; application to the seed furrow), the crop plant, the pest to be controlled, the prevailing climatic conditions, and other factors governed by the method of application, the time of application and the target crop.

A preferred method of application in the area of crop protection is application to the foliage of the plants (foliar application), the number of applications and the rate of application depending on the risk of infestation by the pest and/or fungus in question. However, the active ingredient mixture can also penetrate the plants through the roots (systemic action) if the locus of the plants is impregnated with a liquid formulation or if the active ingredient mixture is incorporated in solid form into the locus of the plants, for example into the soil, e.g. in granular form (soil application). In paddy rice crops, such granules may be applied in metered amounts to the flooded rice field.

The compositions according to the invention are also suitable for protecting plant propagation material, e.g. seed material, such as fruit, tubers or grains, or plant seedlings, from pests and fungi of the mentioned type. The propagation material can be treated with the compositions before planting: seed material, for example, can be dressed before being sown. The compositions can also be applied to seed grains (coating), either by impregnating the grains with a liquid composition or by coating them with a solid composition. The compositions can also be applied to the planting site when the propagation material is being planted, for example to the seed furrow during sowing. The invention relates also to those methods of treating plant propagation material and to the plant propagation material thus treated.

The following Examples are intended to illustrate the invention. They do not limit the invention. Temperatures are given in degrees Celsius.

### FORMULATION EXAMPLES

### %=Percent by Weight; Active Ingredient Ratios=Ratios by Weight

| Example F1: Emulsifiable concentrates | a) | b) | c) |
|---|---|---|---|
| active ingredient mixture [compound (A):compound | 25% | 40% | 50% |
| (B) = 1:3] | | | |
| calcium dodecylbenzenesulfonate | 5% | 8% | 6% |
| castor oil polyethylene glycol ether | 5% | — | — |
| (36 mol of ethylene oxide) | | | |
| tributylphenoxypolyethylene glycol ether | — | 12% | 4% |
| (30 mol of ethylene oxide) | | | |
| cyclohexanone | — | 15% | 20% |
| xylene mixture | 65% | 25% | 20% |

Emulsions of any desired concentration can be prepared from such concentrates by dilution with water.

| Example F2: Solutions | a) | b) | c) | d) |
|---|---|---|---|---|
| active ingredient mixture | 80% | 10% | 5% | 95% |
| [compound (A):compound (B) = 1:10] | | | | |
| ethylene glycol monomethyl ether | 20% | — | — | — |
| polyethylene glycol (mol. wt. 400) | — | 70% | — | — |
| N-methylpyrrolid-2-one | — | 20% | — | — |
| epoxidised coconut oil | — | — | 1% | 5% |
| benzine (boiling range: 160-190°) | — | — | 94% | — |

The solutions are suitable for application in the form of micro-drops.

| Example F3: Granules | a) | b) | c) | d) |
|---|---|---|---|---|
| active ingredient mixture | 5% | 10% | 8% | 21% |
| [compound (A):compound (B) = 2:1] | | | | |
| kaolin | 94% | — | 79% | 54% |
| highly dispersed silicic acid | 1% | — | 13% | 7% |
| attapulgite | — | 90% | — | 18% |

The active ingredient mixture is dissolved in dichloromethane, the solution is sprayed onto the carrier, and the solvent is subsequently evaporated off in vacuo.

| Example F4: Dusts | a) | b) |
|---|---|---|
| active ingredient mixture | 2% | 5% |
| [compound (A):compound (B) = 1:1] | | |
| highly dispersed silicic acid | 1% | 5% |
| talcum | 97% | — |
| kaolin | — | 90% |

Ready-to-use dusts are obtained by intimately mixing the carriers with the active ingredient mixture.

| Example F5: Wettable powders | a) | b) | c) |
|---|---|---|---|
| active ingredient mixture [compound (A):compound | 25% | 50% | 75% |
| (B) = 1:7.5] | | | |
| sodium lignosulfonate | 5% | 5% | — |
| sodium lauryl sulfate | 3% | — | 5% |
| sodium diisobutylnaphthalenesulfonate | — | 6% | 10% |
| octylphenoxypolyethylene glycol ether | — | 2% | — |
| (7-8 mol of ethylene oxide) | | | |
| highly dispersed silicic acid | 5% | 10% | 10% |
| kaolin | 62% | 27% | — |

The active ingredient mixture is mixed with the additives and the mixture is thoroughly ground in a suitable mill, affording wettable powders which can be diluted with water to give suspensions of any desired concentration.

EXAMPLE F6
Extruder granules

| | |
|---|---|
| active ingredient mixture | 10% |
| [compound (A):compound (B) = 1:4] | |
| sodium lignosulfonate | 2% |
| carboxymethylcellulose | 1% |
| kaolin | 87% |

The active ingredient mixture is mixed with the additives, and the mixture is ground, moistened with water, extruded and granulated and the granules are dried in a stream of air.

EXAMPLE F7
Coated granules

| | |
|---|---|
| active ingredient mixture | 3% |
| [compound (A):compound (B) = 1:2] | |
| polyethylene glycol (mol. wt. 200) | 3% |
| kaolin | 94% |

The finely ground active ingredient mixture is uniformly applied, in a mixer, to the kaolin moistened with polyethylene glycol, yielding non-dusty coated granules.

EXAMPLE F8
Suspension concentrate

| | |
|---|---|
| active ingredient mixture | 40% |
| [compound (A):compound (B) = 2:7] | |
| ethylene glycol | 10% |
| nonylphenoxypolyethylene glycol ether | 6% |
| (15 mol of ethylene oxide) | |
| sodium lignosulfonate | 10% |
| carboxymethylcellulose | 1% |
| 37% aqueous formaldehyde solution | 0.2% |
| silicone oil (75% aqueous emulsion) | 0.8% |
| water | 32% |

The finely ground active ingredient mixture is intimately mixed with the additives, giving a suspension concentrate from which suspensions of any desired concentration can be obtained by dilution with water.

It is often more practical for the compound (A) and the compound (B) to be formulated separately and for those formulations then to be brought together in the desired mixing ratio in the applicator in the form of a “tank mixture” in the desired amount of water shortly before application.

### BIOLOGICAL EXAMPLES

### %=Percent by Weight Unless Otherwise Specified

A synergistic effect exists whenever the action We of the active ingredient mixture of a compound (A) and a compound (B) is greater than the sum of the actions of the compound (A) applied alone and the compound (B) applied alone:

We>X+Y

The action to be expected We for a given active ingredient mixture comprising one compound (A) and one compound (B) can, however, also be calculated as follows (cf. COLBY, S. R., “Calculating synergistic and antagonistic response of herbicide combinations”, Weeds 15, pages 20-22, 1967):

$$We = X + \frac{Y ( 100 - X )}{100}$$

wherein:

X=percentage mortality on treatment with the compound (A) at a rate of application of p kg per hectare, compared with the untreated control (=0%).

Y=percentage mortality on treatment with the compound (B) at a rate of application of q kg per hectare, compared with the untreated control.

We=expected action (percentage mortality compared with the untreated control) on treatment with the compound (A) and with the compound (B) at a rate of application of p+q kg per hectare.

When the action actually observed is greater than the value to be expected We, there is a synergistic effect.

### EXAMPLE B1

### Action Against Aphis craccivora

Pea seedlings are infested with Aphis craccivora, subsequently sprayed with a spray mixture comprising 400 ppm of active ingredient mixture and then incubated at 200. Evaluation is made 3 and 6 days later. The percentage reduction in population (% activity) is determined by comparing the number of dead aphids on the treated plants with that on untreated plants.

Active ingredient mixtures according to the invention exhibit good activity in this test.

### EXAMPLE B2

### Action Against Diabrotica balteata

Maize seedlings are sprayed with an aqueous emulsion spray mixture comprising 400 ppm of active ingredient mixture. After the spray-coating has dried, the maize seedlings are populated with 10 Diabrotica balteata larvae (in the second stage) and then placed in a plastics container. The evaluation is made 6 days later. The percentage reduction in population (% activity) is determined by comparing the number of dead larvae on the treated plants with that on untreated plants.

Active ingredient mixtures according to the invention exhibit good activity in this test.

### EXAMPLE B3

### Action Against Heliothis virescens (Foliar Application)

Young soybean plants are sprayed with an aqueous emulsion spray mixture comprising 400 ppm of active ingredient mixture. After the spray-coating has dried, the plants are populated with 10 Heliothis virescens caterpillars (in the first stage) and placed in a plastics container. Evaluation is made 6 days later. The percentage reduction in population and the percentage reduction in feeding damage (% activity) are determined by comparing the treated plants and untreated plants in respect of the number of dead caterpillars and the feeding damage.

Active ingredient mixtures according to the invention exhibit good activity in this test.

### EXAMPLE B4

### Action Against Heliothis virescens (Application to Eggs)

Heliothis virescens eggs deposited on cotton are sprayed with an aqueous emulsion spray mixture comprising 400 ppm of active ingredient mixture. After 8 days, the percentage hatching rate from the eggs and the survival rate of the caterpillars are evaluated (% reduction in population) by comparison with untreated control batches.

Active ingredient mixtures according to the invention exhibit good activity in this test.

### EXAMPLE B5

### Action Against Myzus persicae (Foliar Application)

Pea seedlings are infested with Myzus persicae, subsequently sprayed with a spray mixture comprising 400 ppm of active ingredient mixture and then incubated at 200. Evaluation is made 3 and 6 days later. The percentage reduction in population (% activity) is determined by comparing the number of dead aphids on the treated plants with that on untreated plants.

Active ingredient mixtures according to the invention exhibit good activity in this test.

### EXAMPLE B6

### Action Against Myzus persicae (Systemic Application)

Pea seedlings are infested with Myzus persicae; the roots are subsequently placed in a spray mixture comprising 400 ppm of active ingredient mixture and the seedlings are then incubated at 200. Evaluation is made 3 and 6 days later. The percentage reduction in population (% activity) is determined by comparing the number of dead aphids on the treated plants with that on untreated plants.

Active ingredient mixtures according to the invention exhibit good activity in this test.

### EXAMPLE B7

### Action Against Plutella xylostella Caterpillars

Young cabbage plants are sprayed with an aqueous emulsion spray mixture comprising 400 ppm of active ingredient mixture. After the spray-coating has dried, the plants are populated with 10 Plutella xylostella caterpillars (in the third stage) and placed in a plastics container. Evaluation is made 3 days later. The percentage reduction in population and the percentage reduction in feeding damage (% activity) are determined by comparing the treated plants and untreated plants in respect of the number of dead caterpillars and the feeding damage.

Active ingredient mixtures according to the invention exhibit good activity in this test.

### EXAMPLE B8

### Action Against Spodoptera littoralis Caterpillars

Young soybean plants are sprayed with an aqueous emulsion spray mixture comprising 400 ppm of active ingredient mixture. After the spray-coating has dried, the plants are populated with 10 Spodoptera littoralis caterpillars (in the third stage) and placed in a plastics container. Evaluation is made 3 days later. The percentage reduction in population and the percentage reduction in feeding damage (% activity) are determined by comparing the treated plants and untreated plants in respect of the number of dead caterpillars and the feeding damage.

Active ingredient mixtures according to the invention exhibit good activity in this test.

### EXAMPLE B9

### Action Against Spodoptera littoralis L2

Four week old cotton plants (Gossypium barbadense var. Stoneville) were sprayed with 60 ml sample solution. The following day leaves were placed in petri dishes containing a moist filter paper and 10 L2 larvae placed on the leaves. Petri dishes were covered with gauze and closed with a lid and left at a temperature of 25° C., 40-60% relative humidity and 16L:8D conditions. Assessment of dead and alife larvae was performed after four days. (30 insects assessed per treatment). Examples of the synergistic action of an active ingredient mixture according to the invention is given in the following Tables:

TABLE B1

| | | | Pyroquilon | |
|---|---|---|---|---|
| | | Compound | (1 ppm) + | Expected |
| | Pyroquilon | A-10 | Compound A-10 | mortality |
| | (1 ppm, WP | (0.02 ppm, | (0.02 ppm) | according |
| | 25) | EC 50) | observed mortality | to Colby |
| Mortality | 6.7 | 40 | 56.7 | 44 |

TABLE B2

| | | | Pyroquilon | |
|---|---|---|---|---|
| | | Compound | (1 ppm) + | Expected |
| | Pyroquilon | A-10 | Compound A-10 | mortality |
| | (1 ppm, WP | (0.03 ppm, | (0.03 ppm) observed | according |
| | 25) | EC 50) | mortality | to Colby |
| Mortality | 6.7 | 43.3 | 73.3 | 47.1 |

TABLE B3

| | | | Pyroquilon | |
|---|---|---|---|---|
| | | Compound | (10 ppm) + | Expected |
| | Pyroquilon | A-10 | Compound A-10 | mortality |
| | (10 ppm, | (0.04 ppm, | (0.04 ppm) observed | according |
| | WP 25) | EC 50) | mortality | to Colby |
| Mortality | 6.7 | 70 | 76.7 | 72 |

### EXAMPLE B10

### Action Against Aphis craccivora (Nymphs)

Fourteen day old bean plants (Vicia faba var. Wittkiens) were sprayed with 60 ml sample solution. The following day 3.5 cm leaf disks were cut and placed in petri dishes containing 2 ml agar (2%) and 5-10 adult aphids placed on the leaves. Petri dishes were covered with gauze and closed with a lid and placed up-side down. The following day all adult aphids were removed and only nymphs left on the leaf at a temperature of 20° C., 60% relative humidity and 16L:8D conditions. Assessment of dead and alife aphids performed after four days. (3 replicates per treatment). Examples of the synergistic action of an active ingredient mixture according to the invention is given in the following Table:

TABLE B4

| | | | Pyroquilon | |
|---|---|---|---|---|
| | | Compound | (1 ppm) + | Expected |
| | Pyroquilon | A-10 | Compound A-10 | mortality |
| | (1 ppm, WP | (12.5 ppm, | (12.5 ppm) observed | according |
| | 25) | EC 50) | mortality | to Colby |
| Mortality | 3.3 | 8.7 | 15.7 | 11.7 |

What is claimed is:

1. A pesticidal composition which, in addition to comprising adjuvants, comprises as active ingredients,
a) as component (A), a compound of formula I 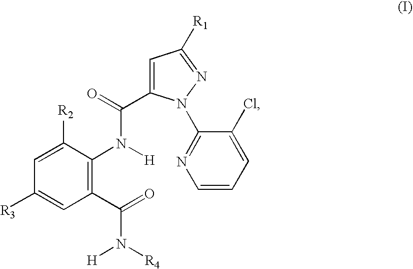
wherein
R₁ is halogen, C₁-C₄haloalkyl or C₁-C₄haloalkoxy;
R₂ is halogen or C₁-C₄alkyl;
R₃ is halogen or cyano; and
R₄ is C₁-C₄alkyl; and
b) as component (B), a synergistically effective amount of at least one active ingredient selected from the group consisting of compounds from the class of azoles, pyrimidinyl carbinols, 2-aminopyrimidines, morpholines, anilinopyrimidines, pyrroles, phenylamides, benzimidazoles, dicarboximides, carboxamides, guanidines, strobilurins, dithiocarbamates, N-halomethylthiotetrahydrophthalimides, copper-containing compounds, nitrophenol derivatives, organo-phosphorus derivatives, a compound of formula F-1 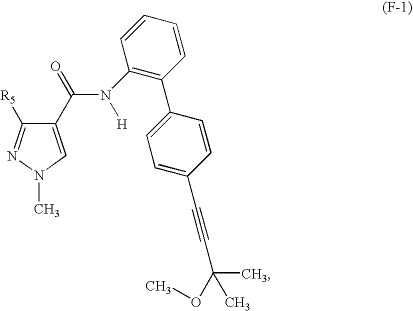
wherein R₅ is trifluoromethyl or difluoromethyl; and a compound of formula F-2 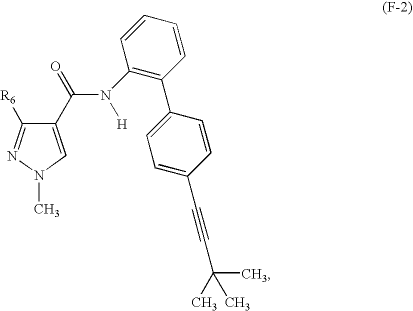
wherein R₆ is trifluoromethyl or difluoromethyl; and a racemic compound of formula F-3 (syn) 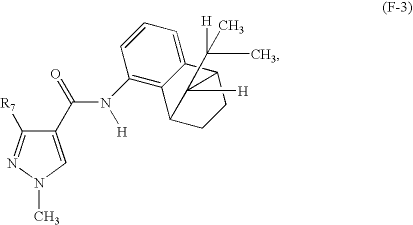
wherein R₇ is trifluoromethyl or difluoromethyl; and a racemic compound of formula F-4 (anti) 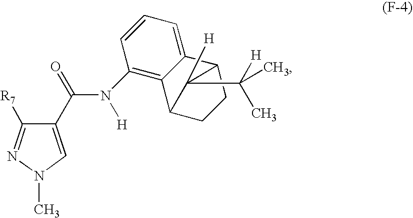
wherein R₇ is trifluoromethyl or difluoromethyl; and a compound of formula F-5 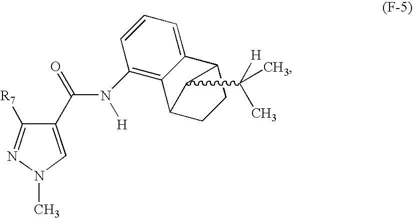
which constitutes an epimeric mixture of the racemic compounds of formulae F-3 (syn) and F-4 (anti), wherein the ratio of the racemic compounds of formula F-3 (syn) to the racemic compounds of formula F-4 (anti) is from 1000:1 to 1:1000 and wherein R₇ is trifluoro-methyl or difluoromethyl; and a compound of formula F-6 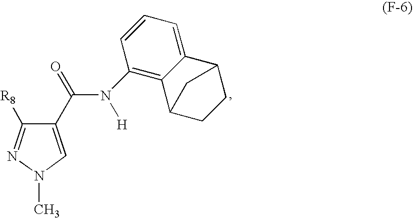
wherein R₈ is trifluoromethyl or difluoromethyl; and a racemic compound of formula F-7 (trans) 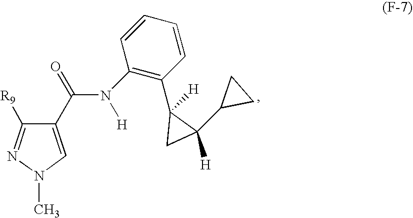
wherein R₉ is trifluoromethyl or difluoromethyl; and a racemic compound of formula F-8 (cis) 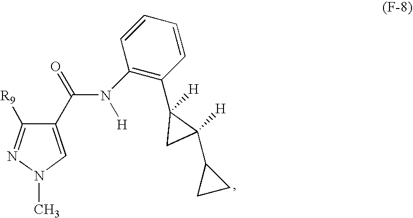
wherein R₉ is trifluoromethyl or difluoromethyl; and a compound of formula F-9 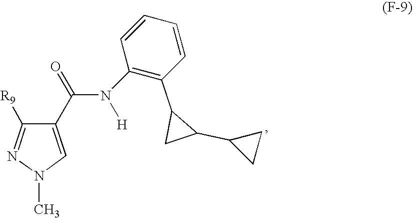
which constitutes a mixture of the racemic compounds of formulae F-7 (trans) and F-8 (cis), wherein the ratio of the racemic compound of formula F-7 (trans) to the racemic compound of formula F-8 (cis) is from 2:1 to 100:1 and wherein R₉ is trifluoromethyl or difluoromethyl; and a compound of formula F-10 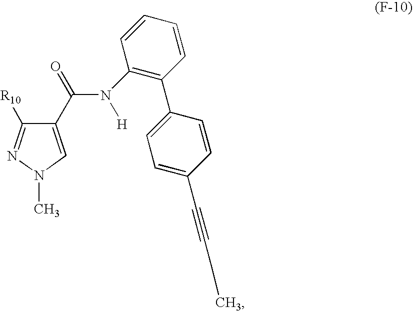
wherein R₁₀ is trifluoromethyl or difluoromethyl; and a racemic compound of formula F-11 (trans) 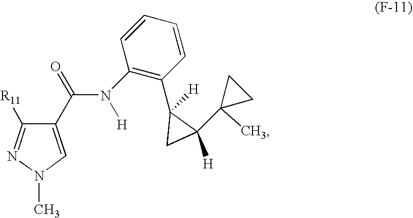
wherein R₁₁ is trifluoromethyl or difluoromethyl; and a racemic compound of formula F-12 (cis) 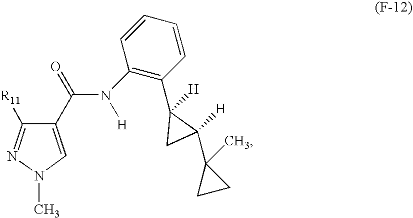
wherein R₁₁ is trifluoromethyl or difluoromethyl; and a compound of formula F-13 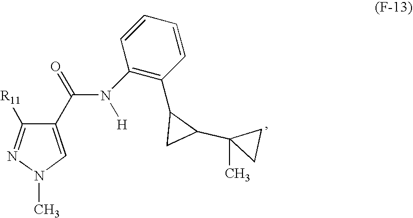
which constitutes a mixture of the racemic compounds of formulae F-11 (trans) and F-12 (cis) and wherein R₁₁ is trifluoromethyl or difluoromethyl; and a compound of formula F-14 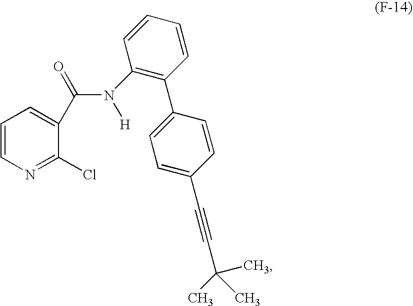
and the compounds acibenzolar-S-methyl, anilazine, benthiavalicarb, blasticidin-S, chinomethionat, chloroneb, chlorothalonil, cyflufenamid, cymoxanil, dichione, diclocymet, diclomezine, dicloran, diethofencarb, dimethomorph, SYP-L190 (flumorph), dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, IKF-916 (cyazofamid), kasugamycin, methasulfocarb, metrafenone, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide (RH7281) and mandipropamid.

2. A composition according to claim 1, which comprises, as component (A), a compound selected from the group consisting of
a compound of formula A-1

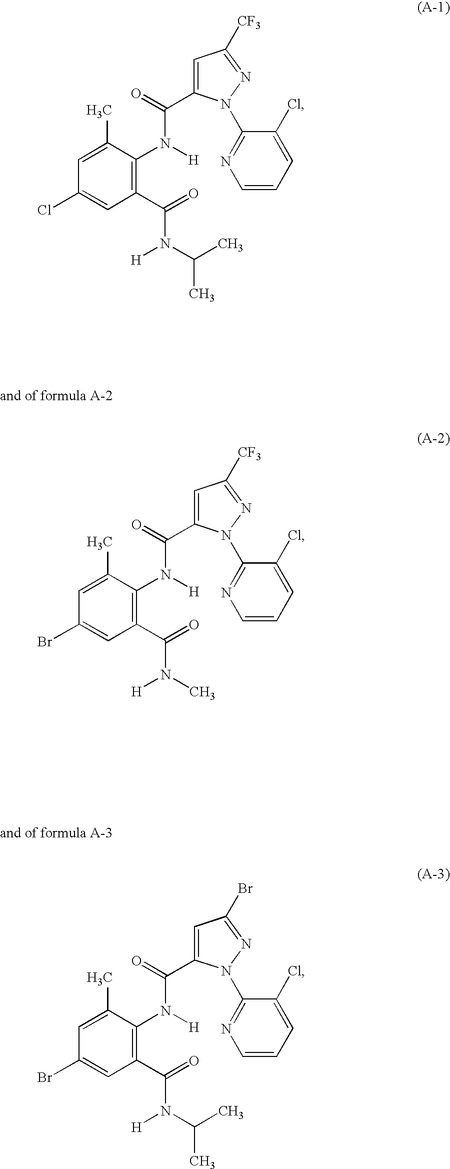

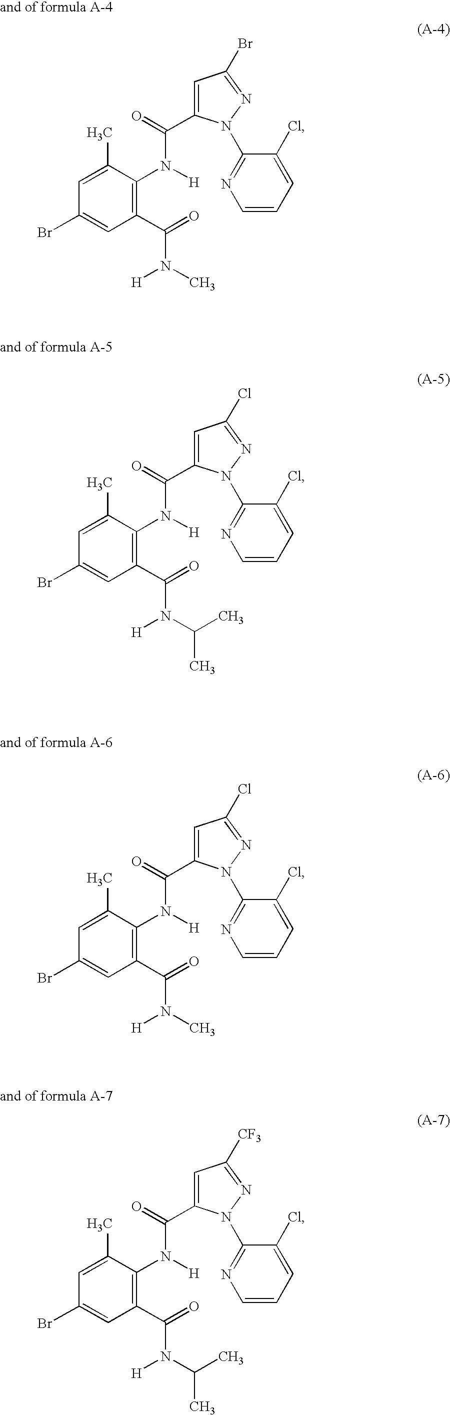

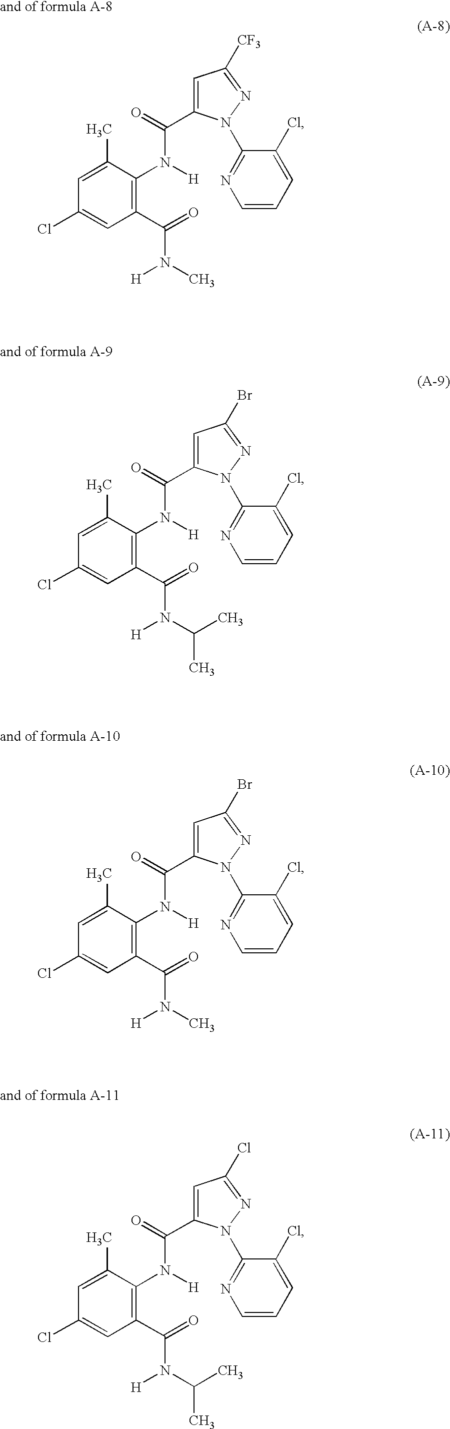

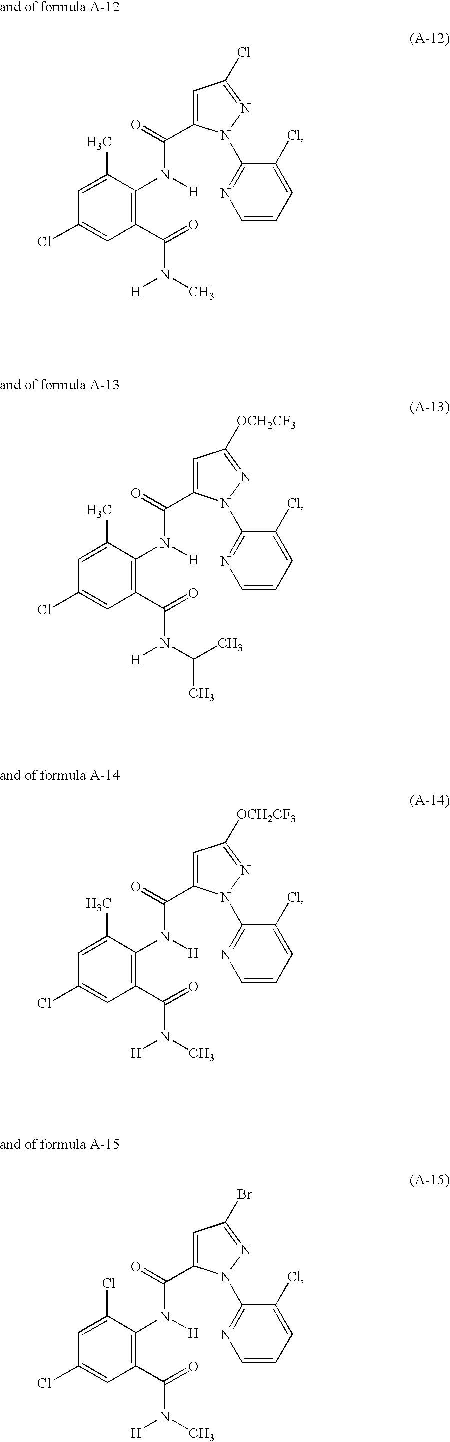

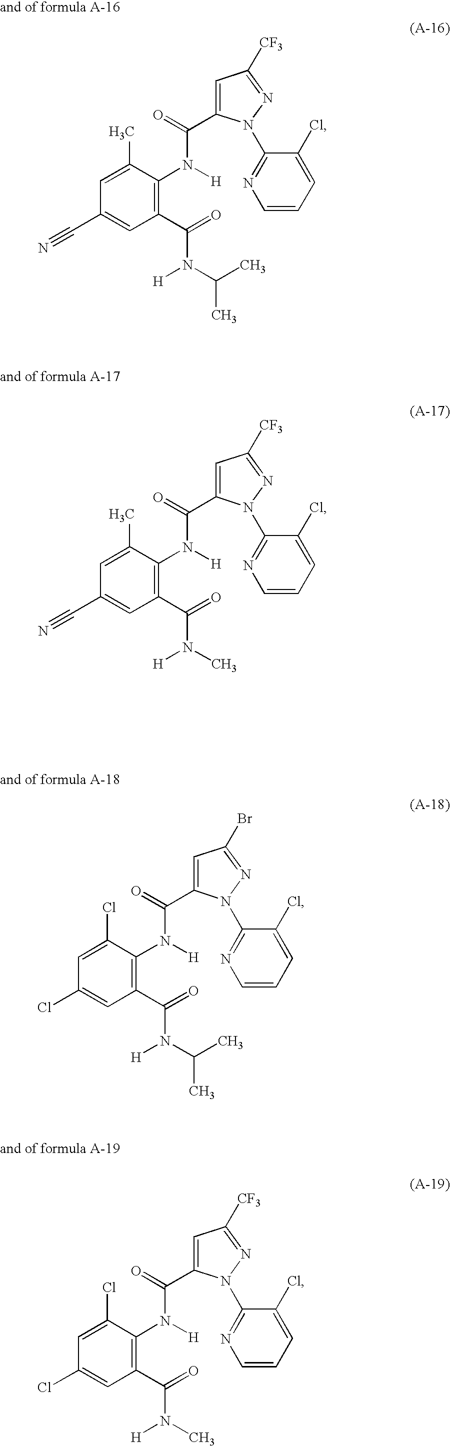

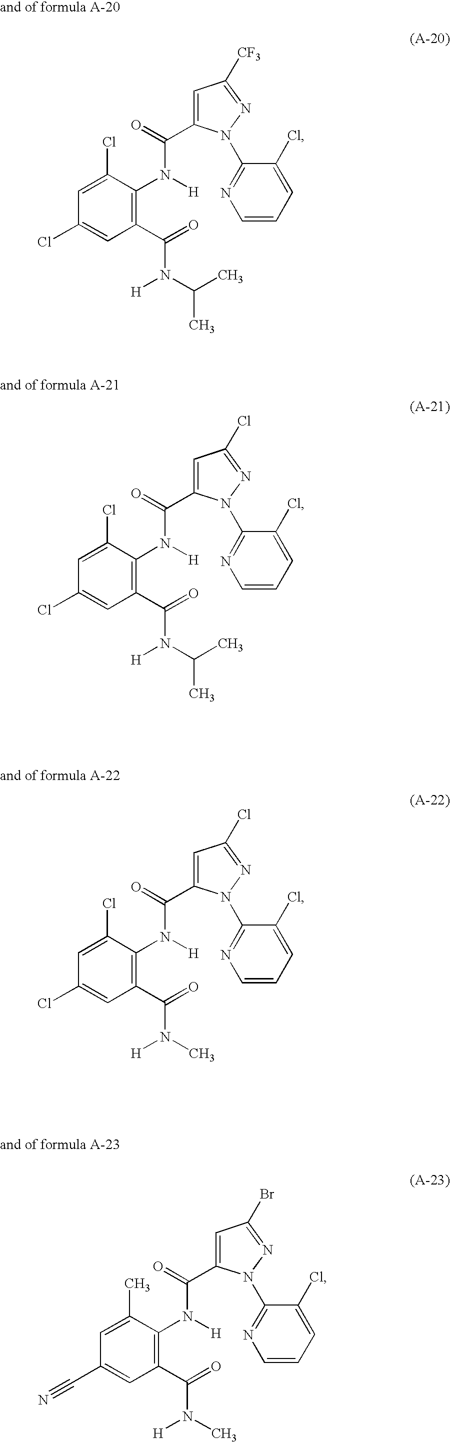

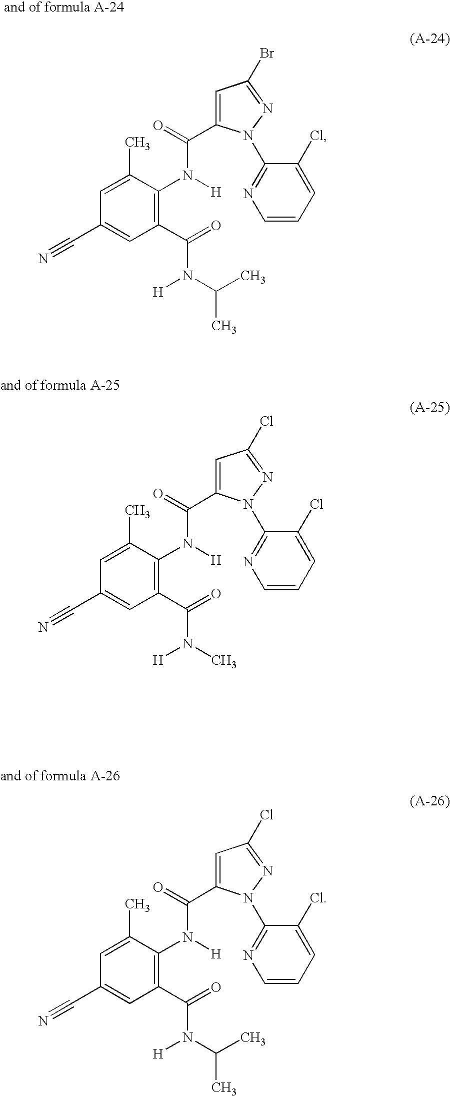

3. A composition according to claim 1, which comprises, as component (B), a compound selected from azoxystrobin, picoxystrobin, cyproconazole, difenoconazole, thiabendazole, propiconazole, fludioxonil, cyprodinil, fenpropimorph, fenpropidin, pyroquilon, metalaxyl, R-metalaxyl and chlorothalonil.

4. A pesticidal composition according to claim 1 which, in addition to comprising adjuvants, consisting of as active ingredients,
a) as component (A), a compound of formula I 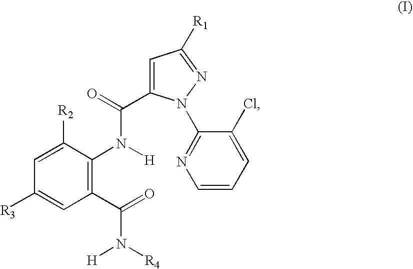
as the only insecticide present in the composition,
wherein
R₁ is halogen, C₁-C₄haloalkyl or C₁-C₄haloalkoxy;
R₂ is halogen or C₁-C₄alkyl;
R₃ is halogen or cyano; and
R₄ is C₁-C₄alkyl; and
b) as component (B), a synergistically effective amount of at least one active ingredient selected from the group consisting of compounds from the class of azoles, pyrimidinyl carbinols, 2-aminopyrimidines, morpholines, anilinopyrimidines, pyrroles, phenylamides, benzimidazoles, dicarboximides, carboxamides, guanidines, strobilurins, dithiocarbamates, N-halomethylthiotetrahydrophthalimides, copper-containing compounds, nitrophenol derivatives, organo-phosphorus derivatives, a compound of formula F-1 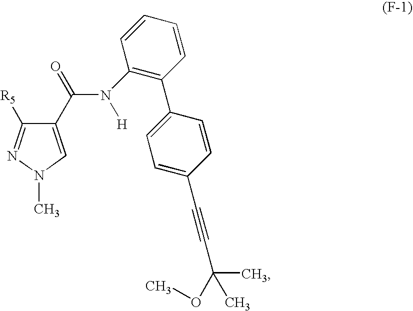
wherein R₅ is trifluoromethyl or difluoromethyl; and a compound of formula F-2 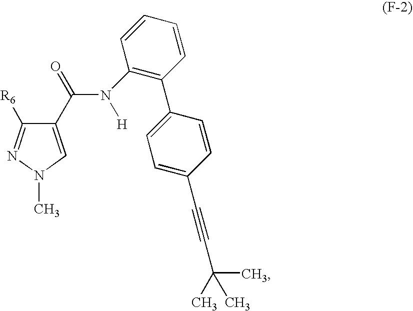
wherein R₆ is trifluoromethyl or difluoromethyl; and a racemic compound of formula F-3 (syn) 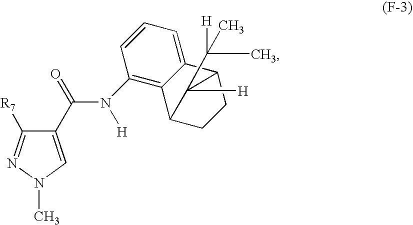
wherein R₇ is trifluoromethyl or difluoromethyl; and a racemic compound of formula F-4 (anti) 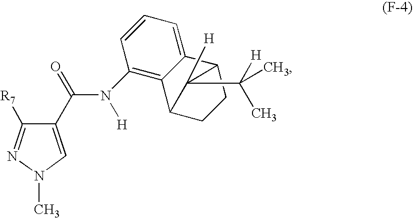
wherein R₇ is trifluoromethyl or difluoromethyl; and a compound of formula F-5 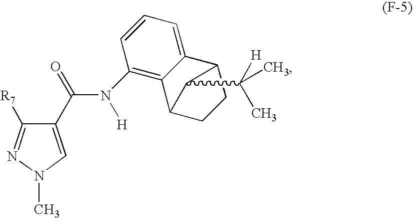
which constitutes an epimeric mixture of the racemic compounds of formulae F-3 (syn) and F-4 (anti), wherein the ratio of the racemic compounds of formula F-3 (syn) to the racemic compounds of formula F-4 (anti) is from 1000:1 to 1:1000 and wherein R₇ is trifluoro-methyl or difluoromethyl; and a compound of formula F-6 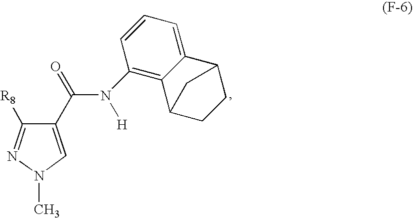
wherein R₈ is trifluoromethyl or difluoromethyl; and a racemic compound of formula F-7 (trans) 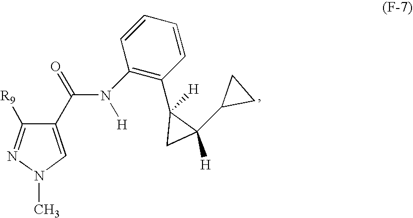
wherein R₉ is trifluoromethyl or difluoromethyl; and a racemic compound of formula F-8 (cis) 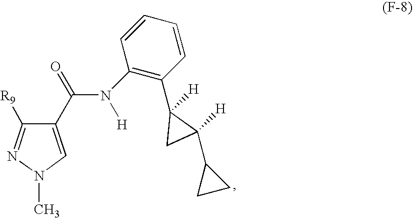
wherein R₉ is trifluoromethyl or difluoromethyl; and a compound of formula F-9 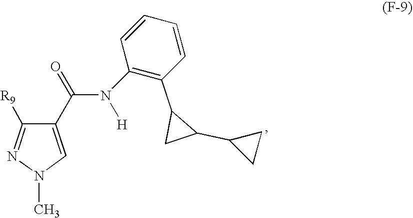
which constitutes a mixture of the racemic compounds of formulae F-7 (trans) and F-8 (cis), wherein the ratio of the racemic compound of formula F-7 (trans) to the racemic compound of formula F-8 (cis) is from 2:1 to 100:1 and wherein R₉ is trifluoromethyl or difluoromethyl; and a compound of formula F-10 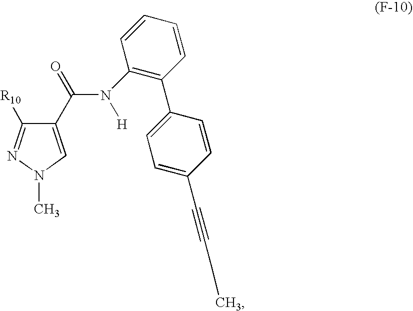
wherein R₁₀ is trifluoromethyl or difluoromethyl; and a racemic compound of formula F-11 (trans) 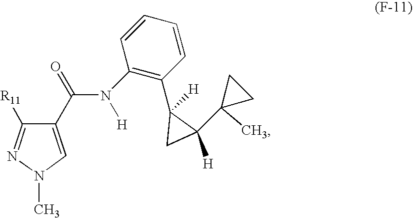
wherein R₁₁ is trifluoromethyl or difluoromethyl; and a racemic compound of formula F-12 (cis) 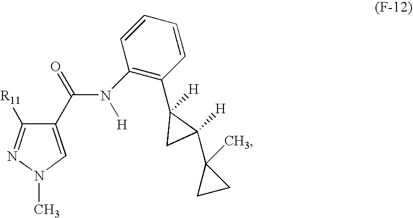
wherein R₁₁ is trifluoromethyl or difluoromethyl; and a compound of formula F-13 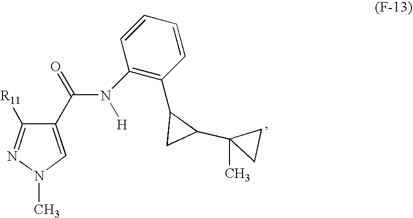
which constitutes a mixture of the racemic compounds of formulae F-11 (trans) and F-12 (cis) and wherein R₁₁ is trifluoromethyl or difluoromethyl; and a compound of formula F-14 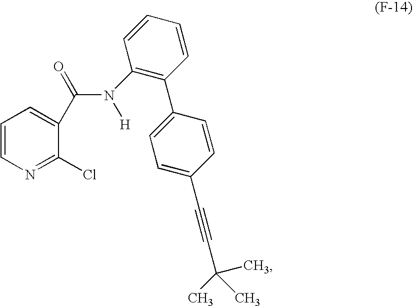
and the compounds acibenzolar-S-methyl, anilazine, benthiavalicarb, blasticidin-S, chinomethionat, chloroneb, chlorothalonil, cyflufenamid, cymoxanil, dichione, diclocymet, diclomezine, dicloran, diethofencarb, dimethomorph, SYP-L190 (flumorph), dithianon, ethaboxam, etridiazole, famoxadone, fenamidone, fenoxanil, fentin, ferimzone, fluazinam, fluopicolide, flusulfamide, fenhexamid, fosetyl-aluminium, hymexazol, iprovalicarb, IKF-916 (cyazofamid), kasugamycin, methasulfocarb, metrafenone, pencycuron, phthalide, polyoxins, probenazole, propamocarb, proquinazid, pyroquilon, quinoxyfen, quintozene, sulfur, tiadinil, triazoxide, tricyclazole, triforine, validamycin, zoxamide (RH7281) and mandipropamid.

5. A method of controlling phytopathogenic microorganisms, insects and Acarina or of preventing such an infestation, which comprises applying a composition according to claim 1 to the infested or threatened site.
